(19) United States
(12) Patent Application Publication
(10) Pub. No.: US 2022/0275244 A1
(43) Pub. Date: Sep. 1, 2022

(54) ORGANIC-INORGANIC HYBRID POLYMERIC COMPOSITIONS, RELATED ARTICLES, AND RELATED METHODS

(71) Applicant: EASTERN MICHIGAN UNIVERSITY, Ypsilanti, MI (US)

(72) Inventors: Vijaykumar M. Mannari, Saline, MI (US); Hamidreza Asemani, Kenosha, WI (US)

(21) Appl. No.: 17/667,685

(22) Filed: Feb. 9, 2022

Related U.S. Application Data
(60) Provisional application No. 63/147,561, filed on Feb. 9, 2021.

(51) Int. Cl. C09D 175/04; B29C 64/124; C08G 18/72; C08G 18/32; C23C 4/04; C23C 4/18; C23C 2/04; C23C 2/26; C08K 5/5415

(52) U.S. Cl. CPC C09D 175/04; B29C 64/124; C08G 18/72; C08G 18/3203; C23C 4/04; C23C 4/18; C23C 2/04; C23C 2/26; C08K 5/5415; B29K 2075/00

(57) ABSTRACT

The disclosure relates to an organic-inorganic hybrid (OIH) polymeric composition and related methods for forming the same. The OIH polymeric composition is generally a networked or crosslinked polymer including an acid- or base-catalyzed reaction product between: a silane compound including at least 3 hydrolysable silyl groups, optionally, a polyisocyanate having at least two isocyanate groups, and optionally, a polyol having at least two hydroxyl groups. The OIH polymeric composition can further include a catalyst remaining after the curing of its monomer components. The OIH polymeric composition can be formed by UV-irradiating a corresponding UV-curable composition including the silane compound and a photo-latent catalyst initiator to form a corresponding catalyst and catalyze the reactions forming the networked polymer. The OIH polymeric composition can be used as a coating on any of a variety of substrates or in an additive manufacturing process.

### CROSS REFERENCE TO RELATED APPLICATION

Priority is claimed to U.S. Provisional Application No. 63/147,561 (filed Feb. 9, 2021), which is incorporated herein by reference in its entirety.

### STATEMENT OF GOVERNMENT INTEREST

None.

### BACKGROUND OF THE DISCLOSURE

### Field of the Disclosure

The disclosure relates to an organic-inorganic hybrid (OIH) polymeric composition and related methods for forming the same. The OIH polymeric composition is generally a networked or crosslinked polymer including an acid- or base-catalyzed reaction product of a silane compound including at least 3 hydrolysable silyl groups. The OIH polymeric composition can be formed by UV-irradiating a corresponding UV-curable composition including the silane compound and a photo-latent catalyst initiator to form a corresponding catalyst and catalyze the reactions forming the networked polymer. The OIH polymeric composition can be used as a coating on any of a variety of substrates or in an additive manufacturing process.

### Background

It is common practice in industry to use a multi-layer protective coating system for corrosion protection and obtaining various properties. Typically, these multi-layer protective coating systems include a conversion pretreatment that is applied directly on the surface followed by a primer, and a top coat. The most common and effective pretreatments used in such protective systems are chromate-based conversion coatings (pretreatments) (CCC). While the CCC provides excellent corrosion resistance and good foundation for adhesion of subsequent organic coatings, strong regulations against the usage of extremely toxic hexavalent chromium, has led to various replacements. Sol-gel pre-treatments are a class of pre-treatments that have attracted lots of attention over the past decades. OIH sol-gel films provide good adhesion between metals and organic primers by formation of functionalized films between metals and organic primers that improves interaction between sol-gel network and primers. The chemistry of silanes (or zirconium and titanium) and their mechanism of interaction with metallic substrates and organic coatings show that silanes, besides providing the adhesion between metal substrates and organic coatings, also provide a thin barrier film against oxygen diffusion to the metal interface.

Many attempts have been made to enhance the performance of sol-gel pretreatments. Some of the examples are introduction of novel precursors using epoxy and urea chemistries, incorporation of corrosion inhibitors in the application formulation, and addition of reactive functionalities to the final sol-gel network (e.g. epoxy, amine, etc.) to provide superior bonding between the pre-treatment layer and subsequently applied topcoat. The sol-gel chemistry, however, is associated with some challenges. The conventional sol-gel application bath preparation is highly sensitive to bath solid content and pH adjustments. Lower solid content further leads to lower film thickness (4-5 microns) which limits the application of sol-gel systems. Moreover, low stability of the bath requires the users to remove the bath constituents more frequently in which hazardous components are present. Last but not least important, sol-gel systems invariably require an additional post-curing (heat curing) to obtain optimum properties.

There has been some considerable research in the field of organic-inorganic hybrid (OIH) coatings. Several chemistries have been used to develop OIH coatings using a variety of photo-initiators. The literature mentions the use of photo-acid and photo-base generators that are used as catalyst. Monomers such as (3-glycidydloxypropyl) trimethoxysilane (GMTMS), urethane methacrylate trimethoxysilane (UAMS) and 2-(3,4-epoxy-cyclohexylethyl) trimethoxysilane (TRIMO) and Vinyltrimethoxysilane (VTMS) have been used to form OIH networks where the silane groups undergo sol-gel process to form the inorganic network and the other functional groups present in the monomer react to form the organic network. This way, the organic and the inorganic parts are connected by a covalent bond. A DBN (1,5-Diazabicyclo[4.3.0]non-5-ene)-based photo-base generator has been used to catalyze thiol-epoxide chemistry.

Utilization of UV curing in presence of a superacid or superbase to achieve an OIH coating network has been performed. Silanes can be crosslinked with a multi-functional acrylate monomer or under appropriate conditions, they can be self crosslinked. Such curing mechanism could eliminate the drawback of bath stability and higher film thicknesses will be obtained. A recent UV curing process is based on generation of an in-situ superbase or superacid that efficiently cures silanes and acrylates. Moreover, highly functional OIH coatings have been developed as a potential substitution for typical primer coatings; such systems entitled “super primers” are constituted of mixture of epoxy resins, acrylates, and organosilanes with different functionalities.

Photo-cure technology has been used in coatings, inks, adhesives, and additive manufacturing (3D-printing) applications. Benefits of photo-curing compared to other technologies include rapid curing, VOC-free compositions, low energy consumption, and efficient processing. The most commonly used, and most commercialized technology within photo-curing relies on UV-induced free-radical polymerization chemistry. While this route has many technical benefits over other technologies such as water-borne coatings, high-solid coatings, it also has a number of inherent limitations such as: oxygen inhibition at the surface (resulting in poor cure at the surface), substantial volume shrinkage, poor adhesion, use of acrylate monomers as reactive diluents that have toxicity, among others. Other chemistries have been used to address the foregoing limitations or for other technical benefits. For example, cationic cure technology using super photo-acid generator has been used to reduce volume shrinkage or to eliminate oxygen inhibition, while photo-base initiated curing provides benefit of reduced oxygen inhibition.

### SUMMARY

In an aspect, the disclosure relates to a method for forming an organic-inorganic hybrid (OIH) polymeric composition, the method comprising: (a) providing a UV-curable composition comprising: (i) a (first) silane compound comprising at least 3 hydrolysable silyl groups, (ii) a photo-latent catalyst initiator, and optionally (iii) a solvent; and (b) exposing the UV-curable composition to UV radiation (i) to generate (or form) a catalyst (e.g., acid or base catalyst) from the photo-latent catalyst initiator and (ii) to subsequently catalyze with the catalyst condensation of silanol groups formed from hydrolysis (e.g., also catalyzed by the catalyst) of the hydrolysable groups, thereby forming an organic-inorganic hybrid (OIH) polymeric composition. In some alternative aspects, the (first) silane compound can be replaced by (or supplemented with) an organozirconium and/or an organotitanium compound having at least 3 (e.g., 3 or 4) hydrolysable groups that can similarly hydrolyze and condense to form a crosslinked cured network. For example, an alternative UV-curable composition can comprise (i) the organozirconium and/or the organotitanium compound (e.g., alone or in combination with the silane compound), (ii) the photo-latent catalyst initiator, and optionally (iii) the solvent. Such an alternative UV-curable composition can be cured, crosslinked, and generally used in any of the various ways described for the silane compound-based UV-curable composition.

The UV-curable composition is generally a non-aqueous mixture or solution in which the silane compound and the photo-latent catalyst initiator are dissolved or mixed together, for example in solution in a suitable (organic) solvent, in particular a solvent that does not promote hydrolysis and/or condensation of the hydrolysable silyl groups prior to application of UV radiation (i.e., as does water). The UV radiation generates the catalyst, generally an acid or base catalyst from a corresponding photolatent acid or base initiator, in situ in the UV-curable composition, and then the catalyst catalyzes the various polymerization reactions, independent of UV radiation. For example, the acid or base catalyst is effective for both hydrolysis of hydrolysable silyl groups (e.g., using ambient moisture or added small quantity of water) to form corresponding silanol groups, and subsequent condensation of the silanol groups to form a crosslinked network. Furthermore, the generated acid or base catalyst may further catalyze other reactions, for example in a dual cure systems, such as one including an isocyanate/hydroxyl reaction, Michael-Addition reaction, etc. More specifically, there is no need to continuously apply UV radiation throughout the curing process; it need only be applied at the beginning to generate the acid or base catalyst, but curing can proceed over a longer period in the absence of UV radiation, including silanol condensation reactions. In some embodiments, the acid or base catalyst can also catalyze hydrolysis of the silane hydrolysable groups to silanol groups. Condensation of silanol groups formed from hydrolysis of the hydrolysable groups can include chain propagation and/or crosslinking of a resulting inorganic network (e.g., Si—O—Si network).

Various refinements of the method for forming an 01H polymeric composition are possible.

In a refinement, the silane compound has a number of hydrolysable silyl groups ranging from 3 to 24. The silane compound is not particularly limited, and it suitably includes any silane compound having at least 3 or at least 6 hydrolysable groups. For example, the silane compound can includes 3 to 24, 6 to 24, or 9 to 24 hydrolysable groups. The silane compound includes multiple hydrolysable groups for inorganic network chain propagation and/or crosslinking. A silane compound with multiple silicon atoms can have an average of at least 1.5 or 2 and/or up to 3 or 3.5 hydrolysable groups per silicon atom. The form of the silane compound is not particularly limited, for example including any suitable organosilicon (e.g., containing Si—C bonds) and/or siloxane (e.g., containing Si—O bonds) structures with at least some of the silicon atoms having hydrolysable group(s) bound thereto. More generally, a silane compound with one or more silicon atoms (e.g., at least 1, 2, 3, or 4 and/or up to 4, 6, 8, or 10 silicon atoms) can have at least 3, 6, 9, 12, 15 or 18 and/or up to 9, 12, 15, 18, 21, or 24 hydrolysable groups total.

In a refinement, the UV-curable composition further comprises: a second silane compound comprising at least 1 hydrolysable silyl group. In general, the primary (or first) silane compound in the UV-curable composition includes at least 3 hydrolysable silyl groups in order to create crosslinked network upon curing. In some cases, the UV-curable composition can include a further (or second) silane compound with 1 hydrolysable silyl group to create a pendant group, or with 2 hydrolysable silyl groups to extend links within the network. In some cases, the UV-curable composition can include a further (or second) silane compound with at least 3 hydrolysable silyl groups as for the primary (or first) silane compound, for example to include different organosilicon and/or siloxane structures into the crosslinked backbone. Thus, in various particular refinements, the second silane compound with one or more silicon atoms (e.g., at least 1, 2, 3, or 4 and/or up to 4, 6, 8, or 10 silicon atoms) can have 1 hydrolysable group total, 2 hydrolysable groups total, at least 3, 6, 9, 12, 15 or 18 hydrolysable groups total, and/or up to 9, 12, 15, 18, 21, or 24 hydrolysable groups total, for example having that same or different number silicon atoms and/or hydrolysable groups as the (first) silane compound.

In a refinement, the hydrolysable silyl groups are selected from the group consisting of alkoxy groups, aryloxy groups, carboxyloxy groups, halogens, and combinations thereof. The hydrolysable (silyl) groups include functional groups attached to a silicon atom (e.g., 1, 2, or 3 functional hydrolysable groups per silicon atom) that can be hydrolyzed under suitable conditions (e.g., when in contact with water, such as when exposed to atmospheric moisture, under acidic conditions, etc.) to form corresponding silanol (Si—OH) functional groups, which in turn can be condensed to form siloxane (Si—O—Si) functional groups/linkages in a cured OIH composition/coating, thus forming the inorganic portion of the composition. The hydrolysable group can include a hydrocarbon group linked via an oxygen atom to a silicon atom (e.g., Si—OR, such as alkoxy groups having 1, 2, 3, or 4 carbon atoms) and/or a halogen atom linked to a silicon atom (e.g., Si—X, such as for F, Cl, Br, or I). Examples of specific hydrolysable groups include silicon-bound methoxy groups and/or ethoxy groups. The hydrolysable groups are generally all the same to promote a uniform rate of hydrolysis/condensation, but the specific groups can be different in an embodiment if desired to have a distribution of different hydrolysis/condensation (e.g., a silane compound including some methoxy groups and some ethoxy groups). The silane compounds are generally hydrolyzed during curing with atmospheric (ambient) moisture. The foregoing hydrolysable silyl groups are suitable for the different silane compounds in the UV-curable composition, for example the first silane compound, the second silane compound (when present), etc. The different silane compounds can have the same or different hydrolysable silyl groups.

As described above, the silane compounds useful according to the disclosure are not particularly limited, typically including any suitable organosilicon and/or siloxane structures with at least some of the silicon atoms having hydrolysable group(s) bound thereto. In some illustrative refinements, the silane compounds can include a curable polyureasil compound or a curable polyepoxy compound as described below, but the UV-curable compositions are not limited to polyureasil or polyepoxy compounds.

In a refinement, the silane compound can be a curable polyureasil compound, for example comprising (A) a hydrocarbon moiety comprising at least 1 or 2 urea groups and (B) at least 3 or 6 hydrolysable silyl groups linked to the hydrocarbon moiety via at least one of the urea groups. In a particular refinement, the silane compound comprises a compound (a polyureasil compound) having the formula (I): R—[—NR₃—CO-NA₁A₂]ₓ (I); (ii) R is selected from the group consisting of hydrocarbons containing from 1 to 50 carbon atoms and heteroatom-substituted hydrocarbons containing from 1 to 50 carbon atoms; (iii) A₁ is represented by —R₁—Si(R₃)_{3-y}X_{y}; (iv) A₂ is represented by —R₂—Si(R₃)_{3-z}X_{z} or H; (v) X is a hydrolysable group independently selected from the group consisting of alkoxy groups, aryloxy groups, carboxyloxy groups, and halogens; (vi) R₁ and R₂ are independently selected from the group consisting of (A) hydrocarbons containing from 1 to 20 carbon atoms and heteroatom-substituted hydrocarbons containing from 1 to 20 carbon atoms when A₂ is not H, and (B) hydrocarbons containing from 2 to 20 carbon atoms and heteroatom-substituted hydrocarbons containing from 2 to 20 carbon atoms when A₂ is H; (vii) R₃ is independently selected from the group consisting of H, hydrocarbons containing from 1 to 20 carbon atoms, and heteroatom-substituted hydrocarbons containing from 1 to 20 carbon atoms; (viii) x is at least 1 or 2; (ix) y is 1, 2, or 3; (x) z is 1, 2, or 3 when A₂ is not H; and (xi) the number of hydrolysable groups X is at least 3 or 6. Examples of such suitable components, for example for the various R and A substituents and other groups above, may be found in Mannari U.S. Publication No. 2012/0258319.

In a refinement, the silane compound can be a curable polyepoxy compound comprising (A) a hydrocarbon moiety comprising at least 1 or 2 epoxide (ring-opened oxirane) groups and (B) at least 3 or 6 hydrolysable silyl groups linked to the hydrocarbon moiety via at least one of the epoxide groups. In a particular refinement, the silane compound comprises a compound (a polyepoxy compound) having the formula (II): R—[—C(OH)R₃-NA₁A₂]ₓ (II); (ii) R is selected from the group consisting of hydrocarbons containing from 1 to 50 carbon atoms and heteroatom-substituted hydrocarbons containing from 1 to 50 carbon atoms; (iii) A₁ is represented by —R₁—Si(R₃)_{3-y}X_{y}; (iv) A₂ is represented by —R₂—Si(R₃)_{3-z}X_{z} or H; (v) X is a hydrolysable group independently selected from the group consisting of alkoxy groups, aryloxy groups, carboxyloxy groups, and halogens; (vi) R₁ and R₂ are independently selected from the group consisting of (A) hydrocarbons containing from 1 to 20 carbon atoms and heteroatom-substituted hydrocarbons containing from 1 to 20 carbon atoms when A₂ is not H, and (B) hydrocarbons containing from 2 to 20 carbon atoms and heteroatom-substituted hydrocarbons containing from 2 to 20 carbon atoms when A₂ is H; (vii) R₃ is independently selected from the group consisting of H, hydrocarbons containing from 1 to 20 carbon atoms, and heteroatom-substituted hydrocarbons containing from 1 to 20 carbon atoms; (viii) x is at least 1 or 2; (ix) y is 1, 2, or 3; (x) z is 1, 2, or 3 when A₂ is not H; and (xi) the number of hydrolysable groups X is at least 3 or 6. Examples of such suitable components, for example for the various R and A substituents and other groups above, may be found in Mannari U.S. Publication No. 2012/0258319.

As described above, an organozirconium compound and/or an organotitanium compound with hydrolysable (and subsequently condensable) groups can be used as a replacement for or supplement to the silane compound in the UV-curable composition. The hydrolysable groups for the organozirconium and organotitanium compounds can generally be the same as described above for the silane compound, for example including alkoxy groups, aryloxy groups, carboxyloxy groups, halogens, and combinations thereof. The organozirconium and organotitanium compounds can have 4 hydrolysable groups, for example being represented by Zr(OR)₄ or Ti(OR)₄, respectively, where OR represents a general alkoxy hydrolysable group as described above such as methoxy, ethoxy, propoxy, isopropoxy, etc.

In a refinement, the photo-latent catalyst initiator comprises a photo-latent base (PLB) initiator and the catalyst formed upon exposure to the UV radiation comprises a base catalyst. Photo-latent base (PLB) systems and related compounds are generally known in the art. In a refinement, the photo-latent base initiator includes a photo-latent base precursor and a blocking group (or blocking moiety). Upon irradiation with UV radiation of appropriate spectral emission, the PLB photolyzes and produces a super-base. Sensitizers can be separately added to increase the efficiency of the photolysis process. The photo-latent base precursor forms or generates the corresponding base catalyst as a reaction product when the precursor and sensitizer are exposed to UV radiation. Example base catalysts include 1,5-Diazabicyclo[4.3.0]non-5-ene (DBN) and 1,8-Diazabicyclo[5.4.0]undec-7-ene (DBU).

The photo-latent base precursor, corresponding base catalyst, and sensitizer are not particularly limited and are generally known to the skilled artisan. More generally, photo-latent base compounds that generate a base catalyst in a pKa range from 5-13, suitably form 11-13, can be used. For example, representative base catalyst compounds belong to the general category of “amidine bases.” Carboxamidines are frequently referred to simply as amidines, as they are the most commonly encountered type of amidine in organic chemistry. Amidines are strong bases (e.g., pKa ranges from 5-13, suitably form 11-13). DBU and DBN have pKa values above 11, and are typically referenced as “super bases.” Sensitizers are separately added along with PLB to enhance the efficiency of photo reaction. Isothioxanthone (ITX) is an example of photosensitizer.

In a refinement, the photo-latent catalyst initiator comprises a photo-latent acid (PLA) initiator and the catalyst formed upon exposure to the UV radiation comprises an acid catalyst. Photo-latent acid (PLA) systems and related compounds are generally known in the art. In a refinement, the photo-latent acid initiator includes a photo-latent acid precursor and a blocking group (or blocking moiety). Upon irradiation with UV radiation of appropriate spectral emission, the PLA photolyzes and produces a super-acid. Sensitizers can be separately added to increase the efficiency of the photolysis process. The photo-latent acid precursor forms the corresponding acid catalyst as a reaction product when the precursor and sensitizer are exposed to UV radiation. Different PLA systems, upon photolysis, produce acids with varying acid strength ranging from pKa values from about +4.8 to −23. The pKa values of the acids generated from the most commonly used PLA systems are in the range of −15 to −23 (or “super acids”). Some examples of such acids include: fluoroantimonic acid (pKa=˜−23 to −21), carborane acid (pKa=˜−18), fluorosulfuric acid (pKa=˜−15.1), and trifflic acid (pKa=˜−15).

In a refinement, the solvent comprises an organic solvent. Any solvent is generally suitable, for example including aromatic hydrocarbons, oxygenated solvents (e.g., alcohols, ethers, ketones) and their combinations. In some embodiments, the solvent is suitably an alcohol such as methanol, ethanol, (iso)propanol, n-butanol, iso-butanol, tert-butanol, and mixtures thereof. The particular alcohol solvent can be selected to correspond to the alcohol that is liberated from the silane compound upon hydrolysis (e.g., an alcohol corresponding to the alkoxy group on the silicon atom). Other non-alcohol solvents that are water-miscible and compatible with silane compound also can be used, for example including acetone and/or tetrahydrofuran (THF).

In a refinement, the UV-curable composition as well as the solvent (when present) is suitably free or substantially free from water to promote the stability of the silane compound(s) and the photocatalyst prior to curing, for example to reduce or prevent hydrolysis and subsequent condensation prior to the desired time for curing. For example the UV-curable composition suitably contains not more than 1 wt. % or 0.1 wt. % water. In various refinements, the UV-curable composition can contain at least 0.0001, 0.001, or 0.01 wt. % water and/or up to 0.01, 0.02, 0.05, 0.1, 0.2, 0.5, or 1 wt. % water. In some embodiments, a minor amount of water can be added to the UV-curable composition just prior to curing/crosslinking to provide some additional water for hydrolysis of the hydrolysable silyl groups (i.e., in addition to environmental or atmospheric water (vapor)). Even after addition of such water, however, the UV-curable composition suitably contains not more than 1 wt. % water, for example in any of the various foregoing ranges/sub-ranges.

In a refinement, the silane compound is present in the UV-curable composition in an amount in a range from 10 wt. % to 95 wt. % or 5 wt. % to 95 wt. % based on the UV-curable composition; the photo-latent catalyst initiator is present in the UV-curable composition in an amount in a range from 1 wt. % to 6 wt. % or 0.1 wt. % to 10 wt. % based on the UV-curable composition; and the solvent (when present) is present in the UV-curable composition in an amount in a range from 0.1 wt. % to 30 wt. % or 0.1 wt. % to 95 wt. % based on the UV-curable composition. More generally, in various refinements, the silane compound(s) (e.g., individually or collectively) can be present in the UV-curable composition in an amount of at least 5, 10, 20, 30, 40, 50, 60, 70, 80, or 90 wt. % and/or up to 30, 45, 60, 70, 80, 90, or 95 wt. % based on the UV-curable composition. The foregoing ranges and sub-ranges for the silane compound can also apply to the total solids content of the UV-curable composition. Similarly, in various refinements, the photo-latent catalyst initiator can be present in the UV-curable composition in an amount of at least 0.5, 1, 1.5, 2, or 3 wt. % and/or up to 3, 4, 5, 6, 7, 8, or 10 wt. % based on the UV-curable composition. Similarly, in various refinements when the solvent is present, the solvent can be present in the UV-curable composition in an amount of at least 0.1, 1, 2, 5, 7, 10, 15, 20, 30, 40, 50, 60, 70, or 80 wt. % and/or up to 10, 20, 25, 30, 35, 45, 55, 65, 75, 85, or 95 wt. % based on the UV-curable composition.

In a refinement, the UV-curable composition further comprises: a polyisocyanate comprising at least two isocyanate groups, and a polyol comprising at least two hydroxyl groups. In some embodiments, the UV-curable composition can include a secondary curing system based on a polyurethane (PU). The polyisocyanate and the polyol can react/cure independently and need not covalently react with the silane compound. Thus, the result can be an interpenetrating network between the organosilane network and the polyurethane. In some embodiments, however, the polyisocyanate and/or the polyol can include a hydrolysable silyl group (e.g., alkoxy group), thus allowing the polyisocyanate, polyol, and/or corresponding polyurethane chain to be covalently incorporated into the network with the silane components. In some embodiments, the UV-generated catalyst can also catalyze the polyisocyanate/polyol reaction for PU formation and/or some reaction of the polyisocyanate or polyol with other OIH network components, for example when the polyisocyanate and/or polyol include a hydrolysable silyl group and/or an MA group. The compositions containing silane compounds, polyols, and polyisocyanates can be prepared as two- or three-component systems (e.g., plural component), and the components can be mixed just prior to curing, for example just prior to application to a substrate. Mannari et al. U.S. Publication No. 2021/0122884 and Mannari U.S. Publication No. 2012/0258319, both of which are incorporated herein in their entireties, provide descriptions of suitable polyisocyanates, polyols, and corresponding polyurethane compositions that can be used.

In a more particular refinement, the polyisocyanate comprises a diisocyanate; and the polyol comprises a diol.

In a more particular refinement, the polyisocyanate is present in the UV-curable composition in an amount in a range from 5 wt. % to 25 wt. % based on the UV-curable composition; and the polyol is present in the UV-curable composition in an amount in a range from 5 wt. % to 70 wt. % based on the UV-curable composition. More generally, in various refinements, the polyisocyanate can be present in the UV-curable composition in an amount of at least 5, 7, 10, or 15 wt. % and/or up to 10, 12, 15, 20, or 25 wt. % based on the UV-curable composition. Similarly, in various refinements, polyol can be present in the UV-curable composition in an amount of at least 5, 10, 15, 20, 30, 40, or 50 wt. % and/or up to 15, 25, 35, 45, 55, 65, or 70 wt. % based on the UV-curable composition.

In a refinement, the UV-curable composition further comprises one or more additives. Suitable additives can include one or more of non-reactive fillers, reinforcements, mineral extenders, wetting agents, flow control agents, pigments (e.g., organic and/or inorganic), corrosion inhibitors (e.g., organic and/or inorganic). The corrosion inhibitor added to the mixture can be any suitable compound known for its corrosion-resistance and/or antioxidant properties. The presence of the corrosion inhibitor in the UV-curable composition mixture allows the inhibitor to be homogeneously dispersed in the eventual cured composition. In some embodiments, organic inhibitors are preferred over inorganic ones, as they generally have little or effect on the pH of the curing mixture, and it is desirable to carefully control the pH value in order to control the kinetics of the hydrolysis and condensation reactions in the mixture. Suitable organic inhibitors include heterocyclic organic compounds having 4 to 20 carbon atoms and one or more heteroatoms (e.g., N, O, S) along with anti-corrosion properties. Specific examples of suitable organic inhibitors include 8-hydroxyquinoline, benzimidazole, mercaptobenzothiazole, mercaptobenzimidazole, benzotriazole, and combinations thereof. The various additives individually or collectively can be included in the UV-curable composition in amounts of at least 0.1 wt. % or 1 wt. % and/or up to 3 wt. % or 5 wt. %. Alternatively or additionally, the various additives individually or collectively can be present in an amount such that its concentration in the OIH polymeric composition is at least 0.1 wt. %, 0.5 wt. %, or 1 wt. % and/or up to 3 wt. %, 5 wt. %, or 10 wt. %.

In a refinement, exposing the UV-curable composition to UV radiation comprises irradiating the UV-curable composition with at least one of a mercury lamp and a UV-LED source. The irradiation source is not particularly limited, and any source with a characteristic spectral distribution in the UV-A and UV-B regions can be used, for example a standard medium pressure mercury lamp. A UV-LED source with wavelength ˜365 nm can also be used.

In a refinement, providing the UV-curable composition in part (a) comprises applying the UV-curable composition to a substrate prior to exposing the UV-curable composition to UV radiation; and exposing the UV-curable composition to UV radiation forms a coating of the OIH polymeric composition on the substrate. Suitably, the organic-inorganic hybrid (OIH) polymeric composition can form a protective coating on any of a variety of substrates, thereby providing a coated article. The uncured composition can be applied as a liquid mixture to the substrate and then exposed to UV radiation for curing, for example by spraying, dipping, etc. Also, similar to other UV-cure coatings, there is film formation limitation. The film thickness should be such that, under a given type of UV-source, and cure process, UV-radiation should penetrate the entire film thickness. In such cases, it can be desirable to apply coatings in multiple application/curing steps to achieve a final desired thickness in a multilayer coating.

In a more particular refinement, the substrate comprises a material selected from the group consisting of metals (e.g., steel), alloys thereof, thermoplastic materials, thermoset materials, composite materials, primer materials, glass, wood, fabric, and ceramic materials. In another refinement, the substrate comprises aluminum. The substrate more generally can include any material other than a cured OIH composition, or it can include a material with a top layer of a cured OIH composition thereon. The substrate is suitably a metallic substrate. In this case, the OIH polymeric composition forms a coating that serves to reduce or prevent corrosion of the underlying metallic substrate from ambient environmental conditions. In various embodiments, the substrate can be a metal (e.g., aluminum), a metal alloy (e.g., an aluminum-containing alloy), or a non-metal. In some embodiments, the OIH polymeric composition is adhered to the substrate via covalent linkages. Many metal substrates (M), including aluminum (Al), contain surface-bound hydroxyl groups (e.g., M-OH or Al—OH, either present natively or after surface preparation by conventional techniques) that themselves can condense during cure with silanol groups in the hydrolyzed silane compound to release water and form an adherent, covalent linking functional group between the metal substrate and the cured silane compound (e.g., [polymer coating]-SiOM-[metal substrate] or [polymer coating]-SiOAl-[aluminum substrate]).

In a more particular refinement, the coating has a thickness in the range of 2 μm to 100 μm. More generally, the coating can have any desired thickness, for example in the range of 1 μm to 100 μm. For example, the coating can be at least 1, 2, 5, 10, 15, or 20 μm and/or up to 5, 10, 20, 30, 40, 50, 60, 80, or 100 μm. An advantage of the disclosed methods and compositions is that single coatings can be formed and cured (e.g., essentially completely cured throughout the entire cross section) with relatively higher thicknesses compared to other sol-gel coating systems, such as wet or water-containing systems. For example, a single coating layer can have a thickness of at least 1, 2, 3, 4, 5, 6, 8, 10, 12, 15, 20, 25, 30, or 40 μm and/or up to 3, 4, 5, 6, 8, 10, 12, 15, 20, 25, 30, 40, 50, 60, 80, or 100 μm. Even thicker films can be obtained by manipulating coating composition and/or increasing the number of applied layers. In general, the coating thickness of a single layer can be controlled primarily by the solids loading of the UV-curable composition (or application bath), and to some extent by the viscosity of the composition. The solids content of the UV-curable composition generally includes all non-volatile components (e.g., components other than those which evaporate after application to a substrate, such as organic, aqueous, or other solvents), for example primarily including the silane compound and any other crosslinking resin components, but also including non-reactive fillers, residual catalyst, etc. For example, the dry film thickness (DFT) of a cured OIH polymeric composition can be about 2-3 μm or 2-4 μm for a solids content of about 10 wt. % (or about 8-15 wt. %), about 4-6 μm or 3-8 μm for a solids content of about 20 wt. % (or about 15-30 wt. %), about 8-12 μm or 6-15 μm for a solids content of about 30 wt. % (or about 20-40 wt. %), and about 20 μm, 15-25 μm, or 12-30 μm for a solids content of about 40 wt. % (or about 30-50 wt. %).

In a more particular refinement, the method further comprises applying a topcoat layer over the coating (i.e., as already applied to a substrate and/or cured). In some embodiments, the coated article with an OIH polymeric composition coating optionally can include a polymeric primer layer and/or a polymeric topcoat layer as additional layers providing barrier/sealant/anti-corrosion properties. The primer layer can be coated on an outer surface of the OIH polymeric composition coating (e.g., the surface opposing that to which the substrate is adhered). Similarly, the topcoat layer is coated on an outer surface of the primer layer (e.g., the surface opposing that to which the OIH polymeric composition coating is adhered). In some embodiments, the primer layer is not present, and the topcoat layer can be coated on the outer surface of the OIH polymeric composition coating (e.g., directly thereon). In addition to providing anti-corrosion properties, the polymeric primer layer additionally promotes adhesion between the OIH polymeric composition coating and the topcoat layer. Such polymeric coatings are suitably chromium-free (e.g., free from hexavalent chromium, trivalent chromium, and/or chromium in any other form). Suitable polymeric materials for the primer and topcoat are generally known and are not particularly limited, with specific examples including epoxy-, polyester-, polyurethane-, polyurea-, and acrylic-based coatings (e.g., where the primer and topcoat suitably have the same or similar base polymeric character, such as polyurethane- or polyurea-based primers/topcoats having hydrogen-bonding donor/acceptor groups for improved wetting and adhesion properties relative to the OIH polymeric composition coating).

In a further refinement, the topcoat layer comprises a further OIH polymer composition layer. For example, the topcoat layer applied over an existing OIH polymer coating can be another layer (or several other layers) of the same or different OIH polymer composition. Such additional layers of OIH polymer compositions can be used in an additive manufacturing process, for example a sterolithography (SLA) additive manufacturing (or 3D printing) process in which the OIH polymer composition serves as the additive manufacturing material. Subsequent layers of the OIH polymer composition can have selected sizes/shapes to provide a desired overall shape of the final additive manufacturing article.

In a refinement, the UV-curable composition is free from Michael-addition (MA) donor and Michael-addition (MA) acceptor compounds.

In a refinement, the UV-curable composition comprises at least one of a Michael-addition (MA) donor and Michael-addition (MA) acceptor compound. In some cases, the UV-curable composition can further include one or more components that undergo a Michael-addition reaction catalyzed by the photo-generated catalyst, for example components containing at least one MA-donor or MA-acceptor functional groups. Upon exposure of radiation, a Michael-addition reaction takes place independent of the silane crosslinking reaction, for example at a lower, equal, or faster reaction rate relative to the silane crosslinking reaction. In some cases, the MA compounds can be added to the UV-curable composition as separate compounds relative to the silane compound. In other cases, it is also possible that MA-donor or MA-acceptor functionality is incorporated into the organic part of the organosilane compounds, such that a covalently connected network including both siloxane crosslinks and MA reaction crosslinks is formed rather than an interpenetrating network of two separate materials.

In another aspect, the disclosure relates to a method of additive manufacturing, the method comprising: applying a first layer of an additive manufacturing component; applying an organic-inorganic hybrid (OIH) polymeric composition according to any of the variously disclosure refinements on the first layer; and applying a second layer of an additive manufacturing component on the OIH polymeric composition. The first layer and the second layer likewise can be OIH polymer composition layers. Subsequent layers of the OIH polymer composition can have selected sizes/shapes to provide a desired overall shape of the final additive manufacturing article.

In another aspect, the disclosure relates to an organic-inorganic hybrid (OIH) polymeric composition formed according to any of the variously disclosure refinements.

In another aspect, the disclosure relates to a coated article form according to any of the variously disclosure refinements.

In another aspect, the disclosure relates to an organic-inorganic hybrid (OIH) polymeric composition comprising: a catalyzed reaction product between: a silane compound comprising at least 3 hydrolysable silyl groups, optionally, a polyisocyanate comprising at least two isocyanate groups, and optionally, a polyol comprising at least two hydroxyl groups; and a catalyst; wherein the reaction product comprises: siloxane condensation bonds of silanol groups formed from hydrolysis of the hydrolysable groups, optionally urethane bonds between the polyisocyanate and the polyol, when present, and optionally bonds linking the polyisocyanate and the polyol, when present, to the OIH structure. The components of the OIH polymeric composition can as generally described above. In a further aspect, the disclosure relates to an coated article comprising: a substrate; and the OIH polymeric composition in any of its various refinements as a coating on a surface of the substrate.

While the disclosed compounds, methods, and compositions are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE FIGURES

FIG. 1 illustrates a UV-curable composition and corresponding method of forming an organic-inorganic hybrid (OIH) polymeric composition according to the disclosure.

FIG. 2 illustrates a coated article according to the disclosure including an OIH polymeric composition with reactive functional groups for interlayer covalent bonding with a paint or topcoat layer and without a primer layer.

FIG. 3 illustrates a dual cure, two-component curing system according to the disclosure, which includes a primary hydrolysable silane compound and secondary polyisocyanate/polyol curing system.

FIG. 4 illustrates a dual cure, two-component curing system according to the disclosure, which includes a primary hydrolysable silane compound and secondary Michael addition curing system.

FIG. 5 illustrates an additive manufacturing process using a dual cure system according to the disclosure.

FIG. 6 illustrates coated article according to the disclosure including a substrate, cured OIH coating, optional primer layer, and optional topcoat layer.

FIG. 7 illustrates two alternative urea-based (top) and epoxy-based (bottom) hydrolysable silane compounds according to the disclosure.

### DETAILED DESCRIPTION

The disclosure generally relates to an organic-inorganic hybrid (OIH) polymeric composition and related methods for forming the same. The OIH polymeric composition is generally a networked or crosslinked polymer including an acid- or base-catalyzed reaction product between: a silane compound including at least 3 hydrolysable silyl groups, optionally, a polyisocyanate having at least two isocyanate groups, and optionally, a polyol having at least two hydroxyl groups. The OIH polymeric composition can further include a catalyst remaining after the curing of its monomer components. The OIH polymeric composition can be formed by UV-irradiating a corresponding UV-curable composition including the silane compound and a photo-latent catalyst initiator to form a corresponding catalyst and catalyze the reactions forming the networked polymer. The OIH polymeric composition can be used as a coating on any of a variety of substrates or in an additive manufacturing process.

The disclosure generally relates to compositions and processes for fabrication of organic-inorganic hybrid (OIH) coating films, optionally with free reactive functional groups (FOIH). The process for fabrication of these OIH or FOIH films (hereinafter referred to as FOIH) involves deposition of wet film by any conventional method, followed by a short-term exposure to ultraviolet radiation (UV) source. Upon UV exposure, the composition (wet film) essentially cures by sol-gel reaction of the reactive precursors in presence of photo-latent acid or photo-latent base catalysts (i.e., photo-activated) present in the composition, typically under ambient conditions of temperature and humidity.

Conventional sol-gel coating systems are currently applied via a method in which a solution of precursor in water/alcohol mixture is prepared and the coating is obtained as a result of hydrolysis and condensation of silanol groups. Despite having several advantages such as elimination of heavy metals, ability to tailor-make the precursor structure, and incorporation of additional functionalities, the current conventional sol-gel coatings are associated with challenges that limits their application. Two main challenges of the conventional sol-gel systems are: (1) lower stability of the application bath, resulting in inflexibility in manufacturing operations, hazardous waste generation, and changes in the bath composition (and hence film properties of the resulting coatings) as function of time, and (2) in ability to deposit a single film thicker than 10 micrometers (typically about 2-6 micrometers maximum for a single layer) due to the limits of the maximum possible concentration of application bath solids (i.e., associated with factor (1) above).

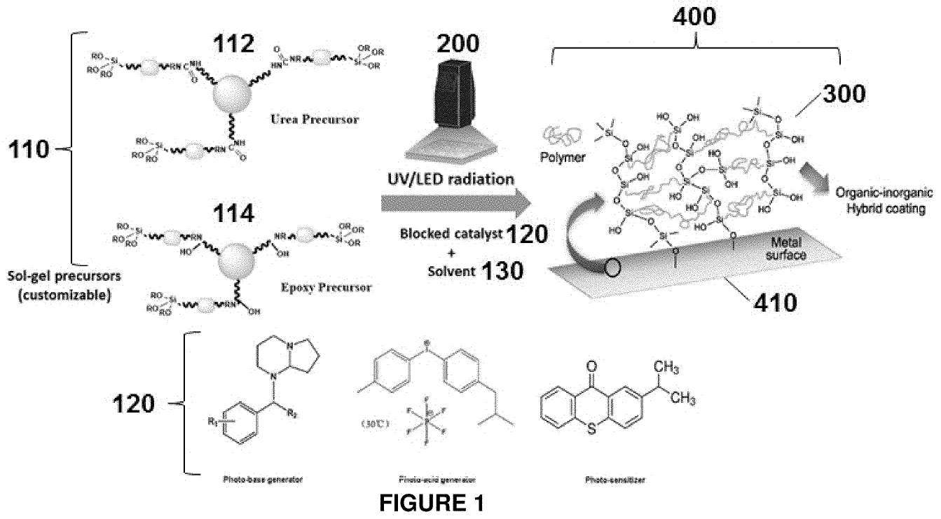

As illustrated in FIG. 1, a coating system according to the disclosure includes a UV-curable composition 100 including hydrolysable organosilane 110 (and/or organozirconium, organotitanium) precursors with various backbone structures, a photolatent acid or photolatent base catalyst (e.g., a photo-latent catalyst initiator 120 that generates a corresponding acid or base catalyst upon UV irradiation), and optionally further components such as one or more organic solvents 130, pigments, additives, etc. Illustrative hydrolysable organosilanes 112, 114 can be based on a urea backbone or epoxy backbone, respectively. These precursors may have reactive functional groups other than hydrolysable silyl groups. Once applied on a surface as a thin film (typically 5-100 micrometer), for example the surface of a metal or other substrate 410, exposure to UV radiation triggers the catalyst to produce an in-situ superbase or superacid. The produced catalyst initiates the hydrolysis and condensation of silanol (and/or other available) groups under ambient humidity conditions to obtain an OIH or FOIH cross-linked compound or network 300 on the substrate 410 surface, thus providing a coated article 400. This unique curing process and mechanism affords two important technical benefits. First, absence of water in the composition 100 and in the application process allows for higher bath concentration of the hydrolysable precursors, and hence higher film thickness. Also, it provides prolongs the stability of the application material/bath. Secondly, by using a photo-latent catalyst in the composition, the additional thermal post-curing step can be eliminated.

Thus, the coating system according to the disclosure allows for application of much thicker OIH or FOIH films without the concerns of storage stability of the application bath, mitigating the challenges of the conventional sol-gel systems. By appropriate selection of sol-gel precursor (e.g., functionality, molecular weight, type of organic structure), film thickness and curing conditions, it is possible to obtain OIH and FOIH films with varying composition and performance for a variety of end-use applications.

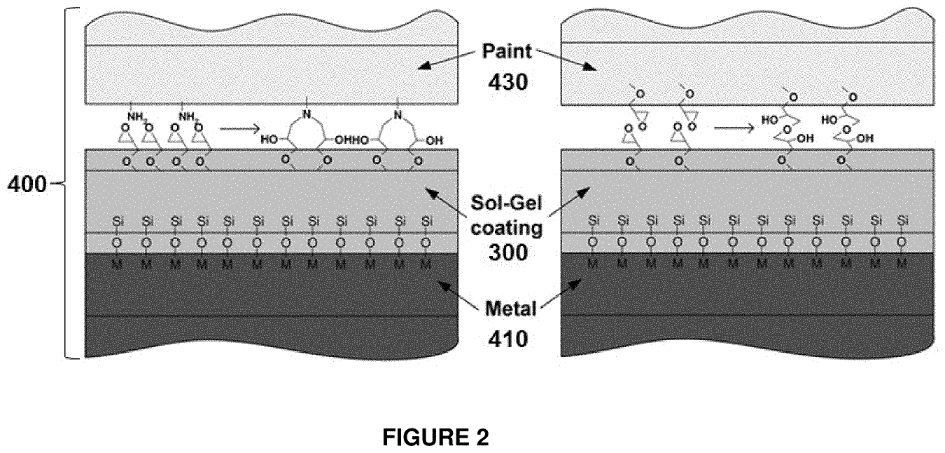

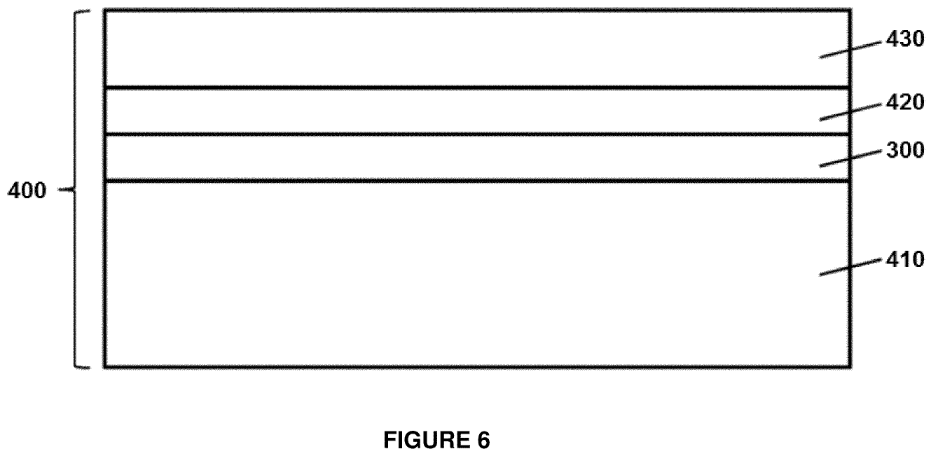

The coating system according to the disclosure provides several advantages, including: (1) the possibility of fabricating FOIH films with reactive functionalities, using functionalized precursors in the composition, (2) the ability to apply and cure thicker films (up to 100 micrometer film vis-a-vis 2-10 micrometer by conventional sol-gel coatings), and (3) a stable composition for the application material (bath) that reduces generation of hazardous waste and associated costs in manufacturing operations. The above features allow the coating system to be used in primer-less coating systems for high-performance anti-corrosive metal finishing applications. Also, such system can be useful as advanced material for additive manufacturing (3D-printing). Due to item (1) above, the FOIH coating system has the possibility of covalent bonding between the FOIH pretreatment layer and the substrate as well as with a subsequently applied organic layer (topcoat). Due to this, superior inter-layer adhesion can be obtained without the need for application of a separate primer layer, which is invariably used in conventional coating systems. This results in significant reduction of cost and energy and improvement of efficiency. FIG. 2 illustrates a schematic of possible interactions of the functionalized FOIH pre-treatment, shown as a cured coating 300 on a metal substrate 410, with a topcoat (or paint) layer 430 without the need for an intervening primer layer (e.g., as illustrated in an optional layer in FIG. 6 discussed below). For example, free functional epoxy groups in the FOIH composition 300 (e.g., such as when using an initial epoxy precursor 114 as the UV-curable component) can react with corresponding amino or epoxy groups in a paint or topcoat layer 430 on the FOIH composition 300 to provide interlayer adhesion/binding without a primer layer.

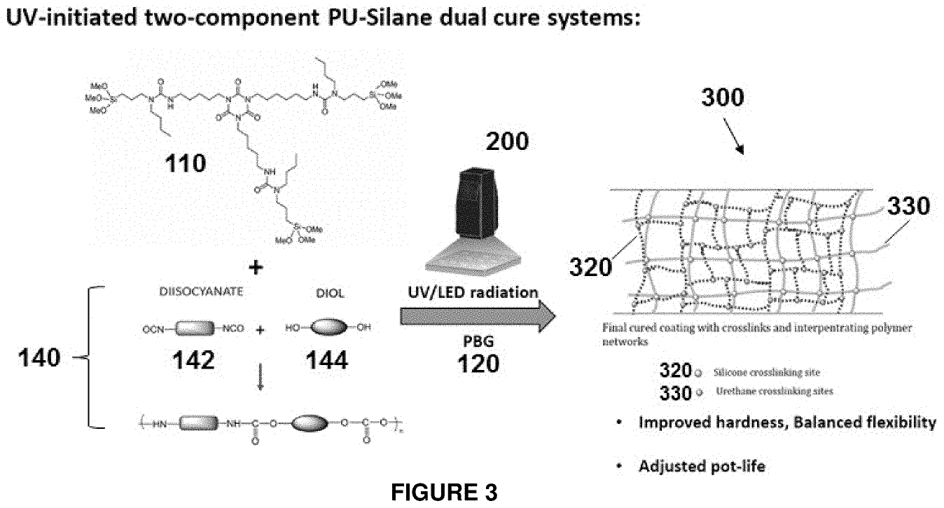

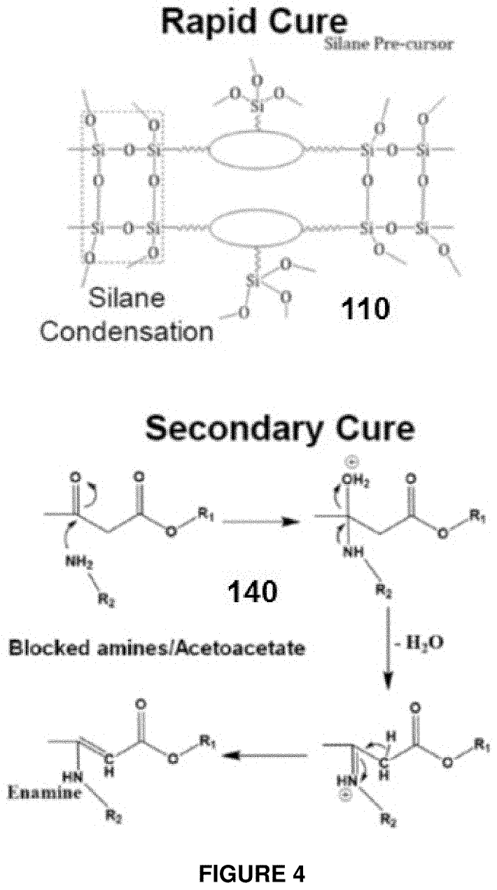

FIGS. 3 and 4 illustrate an extension of the general UV-curable composition 100 that includes a secondary curing system 140 in addition to the primary silane compound 110. In FIG. 3, a silane compound 110 with hydrolysable silyl groups is mixed with secondary curing system 140 including a polyisocyanate 142 and a polyol 144 components for application as wet films to a substrate (not shown). Coatings are then exposed under the UV source 200 and cured. In such dual-cure systems, there are two distinct and independent cure mechanisms—(1) base catalyzed sol-gel reaction via silane functionality, and (2) NCO/OH reaction resulting into the formation of polyurethane network. Due to the kinetics of these two mechanisms under a given catalyst type and amount, such systems will not only produce two interconnected OIH polymer networks by completely different and independent reactions, but will occur at different rate. As illustrated in FIG. 3, the final crosslinked coating or layer 300 includes a first crosslinked polymer 320 based on condensation and crosslinking of the silane compound 110, and a second crosslinked polymer 330 based on crosslinking of the polyisocyanate 142/polyol 144 components of the secondary cure system 140. In this case, while sol-gel reaction would occur rapidly using a latent super-base catalyst in the composition, the NCO/OH reaction would be much slower. FIG. 4 illustrates an alternative to the dual cure system of FIG. 3 in which Michael addition donor/acceptor compounds are used for the secondary curing system 140.

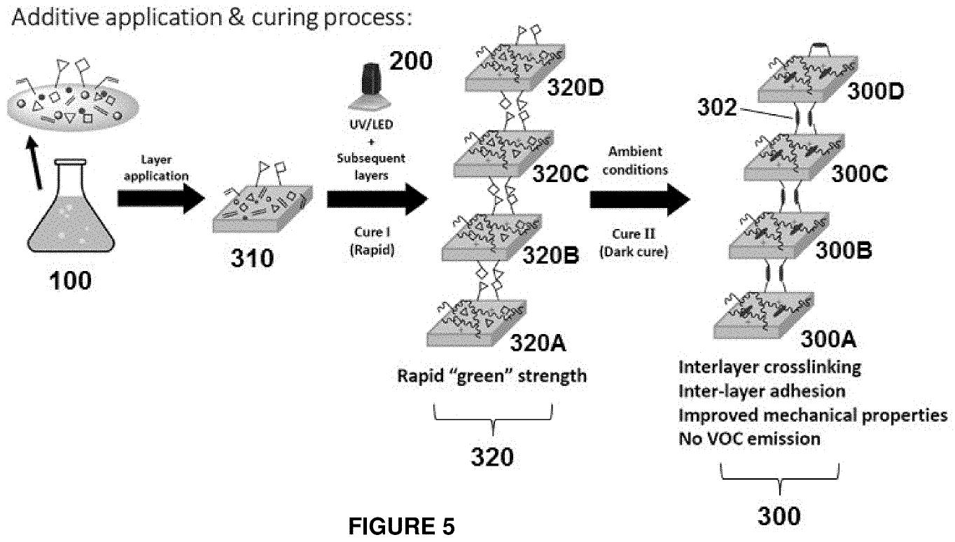

As illustrated in FIG. 5, such dual-cure coating systems can be used in additive manufacturing (AM) applications. When such a system is used for AM process, the first mechanism (1) above will provide green strength and hence faster processability, while the second mechanism (2) will provide inter-layer crosslinking that significantly improves mechanical properties of the final product. As shown in FIG. 5, the UV-curable composition 100, for example including the silane compound 110 and the secondary curing system 140, is applied as a (wet) layer 310, such as on a substrate or on a previously applied AM layer. Each applied layer 310 is subject to UV radiation 200 to form a corresponding “green” or rapid cure layer 320 from the silane compound 110. This is shown in FIG. 5 as a plurality of rapid cure layers 320A-320D collectively defining the rapid cure structure 320 having a desired shape/size for the AM article to be produced. As the article continues to cure in the absence of UV radiation (“dark cure”), for example at ambient conditions of about 20-30° C., the secondary cure system 140 components crosslink to form a plurality of slow cure layers 300A-300D strongly bound with interlayer crosslinks 302 to collectively define the final crosslinked structure 300 also having the desired shape/size for the AM article to be produced. As illustrated in FIG. 3 above, the final crosslinked structure 300 can include an interpenetrating network of the condensed and crosslinked silane compound 110, and the crosslinked secondary cure system 140 components. In the present state of AM processes, many AM articles have poor mechanical properties, which is a major limitation that the disclosed dual-cure compositions have the capability to address. Besides these benefits, the dual-cure system brings another significant advantage that would extend its use in geometrically intricate shapes with recessed areas where UV radiation cannot reach. Since the second mechanism is independent of UV radiation, adequate curing can result in such recessed (shadow areas) areas that are not subjected to UV radiation, even when the composition or article as a whole is exposed to UV radiation.

### UV-Curable Composition

As described above and illustrated in the figures, the UV-curable composition 100 generally includes a silane compound 110, a photo-latent catalyst initiator 120, and optionally a solvent 130. In some embodiments, the UV-curable composition 100 can include a secondary (or additional) curing system 140, for example polyisocyanate/polyol components or Michael addition components, such as in a dual-cure composition 100. In other embodiments, the UV-curable composition 100 can free or substantially free from other secondary curing system components.

In many cases, the silane compound has a number of hydrolysable silyl groups ranging from 3 to 24. The silane compound is not particularly limited, and it suitably includes any silane compound having at least 3 or at least 6 hydrolysable groups. For example, the silane compound can include 3 to 24, 6 to 24, or 9 to 24 hydrolysable groups. The silane compound includes multiple hydrolysable groups for inorganic network chain propagation and/or crosslinking. A silane compound with multiple silicon atoms can have an average of at least 1.5 or 2 and/or up to 3 or 3.5 hydrolysable groups per silicon atom. The form of the silane compound is not particularly limited, for example including any suitable organosilicon (e.g., containing Si—C bonds) and/or siloxane (e.g., containing Si—O bonds) structures with at least some of the silicon atoms having hydrolysable group(s) bound thereto. More generally, a silane compound with one or more silicon atoms (e.g., at least 1, 2, 3, or 4 and/or up to 4, 6, 8, or 10 silicon atoms) can have at least 3, 6, 9, 12, 15 or 18 and/or up to 9, 12, 15, 18, 21, or 24 hydrolysable groups total.

In many cases, the UV-curable composition further includes a second silane compound including at least 1 hydrolysable silyl group. In general, the primary (or first) silane compound in the UV-curable composition includes at least 3 hydrolysable silyl groups in order to create crosslinked network upon curing. In some cases, the UV-curable composition can include a further (or second) silane compound with 1 hydrolysable silyl group to create a pendant group, or with 2 hydrolysable silyl groups to extend links within the network. In some cases, the UV-curable composition can include a further (or second) silane compound with at least 3 hydrolysable silyl groups as for the primary (or first) silane compound, for example to include different organosilicon and/or siloxane structures into the crosslinked backbone. Thus, in various cases, the second silane compound with one or more silicon atoms (e.g., at least 1, 2, 3, or 4 and/or up to 4, 6, 8, or 10 silicon atoms) can have 1 hydrolysable group total, 2 hydrolysable groups total, at least 3, 6, 9, 12, 15 or 18 hydrolysable groups total, and/or up to 9, 12, 15, 18, 21, or 24 hydrolysable groups total, for example having that same or different number silicon atoms and/or hydrolysable groups as the (first) silane compound.

In many cases, the hydrolysable silyl groups are selected from the group consisting of alkoxy groups, aryloxy groups, carboxyloxy groups, halogens, and combinations thereof. The hydrolysable (silyl) groups include functional groups attached to a silicon atom (e.g., 1, 2, or 3 functional hydrolysable groups per silicon atom) that can be hydrolyzed under suitable conditions (e.g., when in contact with water, such as when exposed to atmospheric moisture, under acidic conditions, etc.) to form corresponding silanol (Si—OH) functional groups, which in turn can be condensed to form siloxane (Si—O—Si) functional groups/linkages in a cured OIH composition/coating, thus forming the inorganic portion of the composition. The hydrolysable group can include a hydrocarbon group linked via an oxygen atom to a silicon atom (e.g., Si—OR, such as alkoxy groups having 1, 2, 3, or 4 carbon atoms) and/or a halogen atom linked to a silicon atom (e.g., Si—X, such as for F, Cl, Br, or I). Examples of specific hydrolysable groups include silicon-bound methoxy groups and/or ethoxy groups. The hydrolysable groups are generally all the same to promote a uniform rate of hydrolysis/condensation, but the specific groups can be different if desired to have a distribution of different hydrolysis/condensation (e.g., a silane compound including some methoxy groups and some ethoxy groups). The silane compounds are generally hydrolyzed during curing with atmospheric (ambient) moisture The different silane compounds can have the same or different hydrolysable silyl groups.

As described, the silane compounds useful according to the disclosure are not particularly limited, typically including any suitable organosilicon and/or siloxane structures with at least some of the silicon atoms having hydrolysable group(s) bound thereto. In some illustrative refinements, the silane compounds can include a curable polyureasil compound or a curable polyepoxy compound as described below, but the UV-curable compositions are not limited to polyureasil or polyepoxy compounds.

In many cases, the silane compound can be a curable polyureasil compound, for example including (A) a hydrocarbon moiety including at least 1 or 2 urea groups and (B) at least 3 or 6 hydrolysable silyl groups linked to the hydrocarbon moiety via at least one of the urea groups. In some cases, the silane compound includes a compound (a polyureasil compound) having the formula (I): R—[—NR₃—CO-NA₁A₂]ₓ (I). In formula (I), (i) R is selected from the group consisting of hydrocarbons containing from 1 to 50 carbon atoms and heteroatom-substituted hydrocarbons containing from 1 to 50 carbon atoms; (ii) A₁ is represented by —R₁—Si(R₃)_{3-y}X_{y}; (iii) A₂ is represented by —R₂—Si(R₃)_{3-z}X_{z} or H; (iv) X is a hydrolysable group independently selected from the group consisting of alkoxy groups, aryloxy groups, carboxyloxy groups, and halogens; (v) R₁ and R₂ are independently selected from the group consisting of (A) hydrocarbons containing from 1 to 20 carbon atoms and heteroatom-substituted hydrocarbons containing from 1 to 20 carbon atoms when A₂ is not H, and (B) hydrocarbons containing from 2 to 20 carbon atoms and heteroatom-substituted hydrocarbons containing from 2 to 20 carbon atoms when A₂ is H; and (vi) R₃ is independently selected from the group consisting of H, hydrocarbons containing from 1 to 20 carbon atoms, and heteroatom-substituted hydrocarbons containing from 1 to 20 carbon atoms; (vii) x is at least 1 or 2; (vii) y is 1, 2, or 3; (ix) z is 1, 2, or 3 when A₂ is not H; and (x) the number of hydrolysable groups X is at least 3 or 6.

In a refinement, the silane compound can be a curable polyepoxy compound including (A) a hydrocarbon moiety including at least 1 or 2 epoxide (ring-opened oxirane) groups and (B) at least 3 or 6 hydrolysable silyl groups linked to the hydrocarbon moiety via at least one of the epoxide groups. In some cases, the silane compound includes a compound (a polyepoxy compound) having the formula (II): R—[—C(OH)R₃-NA₁A₂]ₓ (II). In formula (II), (i) R is selected from the group consisting of hydrocarbons containing from 1 to 50 carbon atoms and heteroatom-substituted hydrocarbons containing from 1 to 50 carbon atoms; (ii) A₁ is represented by —R₁—Si(R₃)_{3-y}X_{y}; (iii) A₂ is represented by —R₂—Si(R₃)_{3-z}X_{z} or H; (iv) X is a hydrolysable group independently selected from the group consisting of alkoxy groups, aryloxy groups, carboxyloxy groups, and halogens; (v) R₁ and R₂ are independently selected from the group consisting of (A) hydrocarbons containing from 1 to 20 carbon atoms and heteroatom-substituted hydrocarbons containing from 1 to 20 carbon atoms when A₂ is not H, and (B) hydrocarbons containing from 2 to 20 carbon atoms and heteroatom-substituted hydrocarbons containing from 2 to 20 carbon atoms when A₂ is H; (vi) R₃ is independently selected from the group consisting of H, hydrocarbons containing from 1 to 20 carbon atoms, and heteroatom-substituted hydrocarbons containing from 1 to 20 carbon atoms; (vii) x is at least 1 or 2; (viii) y is 1, 2, or 3; (ix) z is 1, 2, or 3 when A₂ is not H; and (x) the number of hydrolysable groups X is at least 3 or 6.

Various options are possible for the substituents of the silane compound according to formula (I) or formula (II). R can be a hydrocarbon moiety or a heteroatom-substituted hydrocarbon moiety (e.g., N, O, S substituted) containing from 1 to 50 carbon atoms, for example at least 2, 4, 8, or 12 and/or up to 20, 30, 40, or 50 carbon atoms. A₁ contains hydrolysable silyl groups and can be represented by —R₁—Si(R₃)_{3-y}X_{y}. A₂ can contain hydrolysable silyl groups and can be represented by —R₂—Si(R₃)_{3-z}X_{z} (i.e., with silyl groups) or H or R₃ (i.e., without silyl groups). X can be a hydrolysable group such as an alkoxy group, an aryloxy group, a carboxyloxy group, or a halogen, for example having at least having 1, 2, 3, or 4 and/or up to 4, 6, 8, 10, or 12 carbon atoms for non-halogens, where X can be the same or different on any particular silicon atom. R₁ and R₂ can be a hydrocarbon moiety or a heteroatom-substituted hydrocarbon moiety (e.g., N, O, S substituted) containing from 1 to 20 carbon atoms, for example at least 2, 4, 8, or 12 and/or up to 4, 8, 12, 16, or 20 carbon atoms, where R₁ and R₂ can be the same or different. R₃ can be hydrogen or a hydrocarbon moiety or a heteroatom-substituted hydrocarbon moiety (e.g., N, O, S substituted) containing from 1 to 20 carbon atoms, for example at least 2, 4, 8, or 12 and/or up to 4, 8, 12, 16, or 20 carbon atoms. R₃ can be selected in its various instances (e.g., explicitly illustrated in formula (I), formula (II), or as a component of A₁ or A₂) to be the same or different. The value x corresponds to the number of urea groups or epoxide-opened hydroxy groups in the curable formula (I) or formula (II) compound and can be at least 2, 3, 4 and/or up to 3, 4, 6, 8, or 10. The specific selections for R₁-R₃, A₁, A₂, and X can be the same or different in each of the “x” instances of the formula (I) or formula (II) structure I (e.g., for x=2 or higher, the substituents in the repeated unit can be the same or different). The values y and z correspond to the number of hydrolysable silyl groups in A₁ or A₂ (i.e., when A₂ is not H or R₃), respectively, and they independently can be 1, 2, or 3. The product (x)(y) or (x)(y+z) can reflect the total number of hydrolysable silyl groups in the curable formula (I) or formula (II) compound and suitably can be at least 3, at least 6, or more than 6.

The hydrocarbon groups/moieties in the various components of the curable formula (I) or formula (II) compound generally can include saturated or unsaturated, linear or branched aliphatic hydrocarbon groups, alicyclic hydrocarbon groups, aryl hydrocarbon groups, and heteroatom-including analogs/derivates of the same (e.g., including N, O, S heteroatoms). The hydrocarbon groups (R, R₁, R₂, or R₃) additionally can include hydrolysable silyl groups (i.e., in addition to those explicitly illustrated in A₁ and A₂). As noted above, the hydrolyzable X groups can be the same in all instances in the curable compound to promote uniform hydrolysis and condensation rates, but they can be different in alternate embodiments.

The disclosed curable formula (I) or formula (II) compound has a high reactivity (e.g., promoting rapid and extensive curing), a robust chemical structure (e.g., providing resistance to degradation), and excellent mechanical properties once cured (e.g., in the form of a film on a substrate). The specific chemical structure and functional groups of the curable compound can be selected and synthesized by reaction between one or more aminosilanes (e.g., aminoalkyl[mono-, di-, or tri-]alkoxysilanes) with (A) one or more polyisocyanates (e.g., di- or tri-isocyanates), for example in equivalent (molar) proportions based on the amino and isocyanate functional groups, to yield formula (I) compounds, or with (B) one or more polyepoxides (e.g., di- or tri-epoxide), for example in equivalent (molar) proportions based on the amino and epoxide functional groups, to yield formula (II) compounds. Thus, the hydrocarbon moiety of the formula (I) or formula (II) compound has a structure corresponding to a reaction product resulting from an amination reaction of the polyisocyanate or polyepoxide with the aminosilane. The strong hydrogen-bonding interactions between organic components within the cross-linked hybrid network provides improved coating performance.

Suitable polyisocyanates and polyepoxides useable as a precursor to the hydrocarbon moiety of the curable compound include any organic compound having at least two free isocyanate groups or at least two free epoxide groups per molecule (e.g., 2, 3, or 4 isocyanate or epoxide groups), for example having about 4 to 20 or 4 to 50 carbon atoms (in addition to nitrogen, oxygen, and hydrogen) and including aliphatic, cycloaliphatic, aryl-aliphatic, and aromatic compounds with the isocyanate or epoxide groups. In various embodiments, the polyisocyanate or polyepoxide precursor can include at least 4, 6, 8, 10, 12, 15, 20, or 30 carbon atoms and/or up to 10, 12, 15, 20, 25, 30, 35, 40, or 50 carbon atoms.

Suitable animosilanes useable as a precursor to the hydrolysable silyl groups of the curable compound include any organic compound having one or more amine groups (e.g., free primary or secondary amino group) and one or more hydrolysable silyl groups per molecule (e.g., 1, 2, 3, 4, 5, or 6 hydrolysable silyl groups with 1 or 2 corresponding silicon atoms). The animosilanes are suitably monoamines. The animosilanes can have a hydrocarbon group having at least 1 or 2 and/or up to 6 or 10 carbon atoms that links the amino group with the hydrolysable silyl groups (e.g., with the amino group and the corresponding silicon atom at opposing terminal ends of the linking group). Suitable aminosilanes can be represented by the form NHA₁A₂, where A₁, A₂, X, and R₁-R₃ are as described above for the curable formula (I) or formula (II) compound. Specific examples of suitable aminosilanes include (3-aminopropyl)trialkoxysilane (e.g., including trimethoxy (APTMS) and triethoxy (APTES) species) and bis(3-trialkoxysilylpropyl)amine (e.g., including trimethoxy (BTMSPA) and triethoxy (BTESPA) species).

In addition, an organozirconium compound and/or an organotitanium compound with hydrolysable (and subsequently condensable) groups can be used as a replacement for or supplement to the silane compound in the UV-curable composition. The hydrolysable groups for the organozirconium and organotitanium compounds can generally be the same as described above for the silane compound, for example including alkoxy groups, aryloxy groups, carboxyloxy groups, halogens, and combinations thereof. The organozirconium and organotitanium compounds can have 4 hydrolysable groups, for example being represented by Zr(OR)₄ or Ti(OR)₄, respectively, where OR represents a general alkoxy hydrolysable group as described above such as methoxy, ethoxy, propoxy, isopropoxy, etc.

In many cases, the photo-latent catalyst initiator includes a photo-latent acid (PLA) initiator and the catalyst formed upon exposure to the UV radiation includes an acid catalyst. Photo-latent acid (PLA) systems and related compounds are generally known in the art. In some cases, the photo-latent acid initiator includes a photo-latent acid precursor and a blocking group (or blocking moiety). Upon irradiation with UV radiation of appropriate spectral emission, the PLA photolyzes and produces a super-acid. Sensitizers can be separately added to increase the efficiency of the photolysis process. The photo-latent acid precursor forms the corresponding acid catalyst as a reaction product when the precursor and sensitizer are exposed to UV radiation. Different PLA systems, upon photolysis, produce acids with varying acid strength ranging from pKa values from about +4.8 to −23. The pKa values of the acids generated from the most commonly used PLA systems are in the range of −15 to −23 (or “super acids”). Some examples of such acids include: fluoroantimonic acid (pKa=˜−23 to −21), carborane acid (pKa=˜−18), fluorosulfuric acid (pKa=˜−15.1), and trifflic acid (pKa=˜−15).

In many cases, the photo-latent catalyst initiator includes a photo-latent base (PLB) initiator and the catalyst formed upon exposure to the UV radiation includes a base catalyst. Photo-latent base (PLB) systems and related compounds are generally known in the art. In some cases, the photo-latent base initiator includes a photo-latent base precursor and a blocking group (or blocking moiety). Upon irradiation with UV radiation of appropriate spectral emission, the PLB photolyzes and produces a super-base. Sensitizers can be separately added to increase the efficiency of the photolysis process. The photo-latent base precursor forms or generates the corresponding base catalyst as a reaction product when the precursor and sensitizer are exposed to UV radiation. Example base catalysts include 1,5-Diazabicyclo[4.3.0]non-5-ene (DBN) and 1,8-Diazabicyclo[5.4.0]undec-7-ene (DBU).

The photo-latent base precursor, corresponding base catalyst, and sensitizer are not particularly limited and are generally known to the skilled artisan. More generally, photo-latent base compounds that generate a base catalyst in a pKa range from 5-13, suitably form 11-13, can be used. For example, representative base catalyst compounds belong to the general category of “amidine bases.” Carboxamidines are frequently referred to simply as amidines, as they are the most commonly encountered type of amidine in organic chemistry. Amidines are strong bases (e.g., pKa ranges from 5-13, suitably form 11-13). DBU and DBN have pKa values above 11, and are typically referenced as “super bases.” Sensitizers are separately added along with PLB to enhance the efficiency of photo reaction. Isothioxanthone (ITX) is an example of photosensitizer.

In many cases, the solvent includes an organic solvent. Any solvent is generally suitable, for example including aromatic hydrocarbons, oxygenated solvents (e.g., alcohols, ethers, ketones) and their combinations. In some cases, the solvent is suitably an alcohol such as methanol, ethanol, (iso)propanol, n-butanol, iso-butanol, tert-butanol, and mixtures thereof. The particular alcohol solvent can be selected to correspond to the alcohol that is liberated from the silane compound upon hydrolysis (e.g., an alcohol corresponding to the alkoxy group on the silicon atom). Other non-alcohol solvents that are water-miscible and compatible with silane compound also can be used, for example including acetone and/or tetrahydrofuran (THF).

In many cases, the UV-curable composition as well as the solvent (when present) is suitably free or substantially free from water to promote the stability of the silane compound(s) and the photocatalyst prior to curing, for example to reduce or prevent hydrolysis and subsequent condensation prior to the desired time for curing. For example the UV-curable composition suitably contains not more than 1 wt. % or 0.1 wt. % water. In various cases, the UV-curable composition can contain at least 0.0001, 0.001, or 0.01 wt. % water and/or up to 0.01, 0.02, 0.05, 0.1, 0.2, 0.5, or 1 wt. % water. In some cases, a minor amount of water can be added to the UV-curable composition just prior to curing/crosslinking to provide some additional water for hydrolysis of the hydrolysable silyl groups (i.e., in addition to environmental or atmospheric water (vapor)). Even after addition of such water, however, the UV-curable composition suitably contains not more than 1 wt. % water, for example in any of the various foregoing ranges/sub-ranges.

In many cases, the silane compound is present in the UV-curable composition in an amount in a range from 10 wt. % to 95 wt. % or 5 wt. % to 95 wt. % based on the UV-curable composition; the photo-latent catalyst initiator is present in the UV-curable composition in an amount in a range from 1 wt. % to 6 wt. % or 0.1 wt. % to 10 wt. % based on the UV-curable composition; and the solvent (when present) is present in the UV-curable composition in an amount in a range from 0.1 wt. % to 30 wt. % or 0.1 wt. % to 95 wt. % based on the UV-curable composition. More generally, in various cases, the silane compound(s) (e.g., individually or collectively) can be present in the UV-curable composition in an amount of at least 5, 10, 20, 30, 40, 50, 60, 70, 80, or 90 wt. % and/or up to 30, 45, 60, 70, 80, 90, or 95 wt. % based on the UV-curable composition. The foregoing ranges and sub-ranges for the silane compound can also apply to the total solids content of the UV-curable composition. Similarly, in various cases, the photo-latent catalyst initiator can be present in the UV-curable composition in an amount of at least 0.5, 1, 1.5, 2, or 3 wt. % and/or up to 3, 4, 5, 6, 7, 8, or 10 wt. % based on the UV-curable composition. Similarly, in various cases when the solvent is present, the solvent can be present in the UV-curable composition in an amount of at least 0.1, 1, 2, 5, 7, 10, 15, 20, 30, 40, 50, 60, 70, or 80 wt. % and/or up to 10, 20, 25, 30, 35, 45, 55, 65, 75, 85, or 95 wt. % based on the UV-curable composition.

In many cases, the UV-curable composition further includes: a polyisocyanate including at least two isocyanate groups, and a polyol including at least two hydroxyl groups. In some cases, the UV-curable composition can include a secondary curing system based on a polyurethane (PU). The polyisocyanate and the polyol can react/cure independently and need not covalently react with the silane compound. Thus, the result can be an interpenetrating network between the organosilane network and the polyurethane. In some cases, however, the polyisocyanate and/or the polyol can include a hydrolysable silyl group (e.g., alkoxy group), thus allowing the polyisocyanate, polyol, and/or corresponding polyurethane chain to be covalently incorporated into the network with the silane components. In some cases, the UV-generated catalyst can also catalyze the polyisocyanate/polyol reaction for PU formation and/or some reaction of the polyisocyanate or polyol with other OIH network components, for example when the polyisocyanate and/or polyol include a hydrolysable silyl group and/or an MA group. The compositions containing silane compounds, polyols, and polyisocyanates can be prepared as two- or three-component systems (e.g., plural component), and the components can be mixed just prior to curing, for example just prior to application to a substrate. In some cases, the polyisocyanate includes a diisocyanate, and the polyol includes a diol.

Polyisocyanate and Polyol Compounds: The polyfunctional isocyanate (or polyisocyanate) and polyfunctional hydroxy (or polyol) compounds suitable for forming a corresponding polyurethane are not particularly limited and are generally known in the art. In some embodiments, the polyisocyanate and polyol compounds are selected such that they react and polymerize independently of the silane compound (i.e., as a separate polymeric network). In other embodiments, the polyisocyanate and polyol compounds are selected such that they react and polymerize with each other and with the silane compound (i.e., as a combined polymeric network).

In a particular refinement, the polyisocyanate includes a diisocyanate. Suitable polyisocyanates include any organic compound having at least two free isocyanate (—NCO) groups per molecule (e.g., 2, 3, or 4 isocyanate groups, such as an average of 2-4 isocyanate groups per molecule), for example having about 4 to 20 carbon atoms (in addition to nitrogen, oxygen, and hydrogen) and including aliphatic, cycloaliphatic, aryl-aliphatic, and aromatic polyisocyanates, as well as products of their oligomerization, used alone or in mixtures of two or more. Suitable polyisocyanates are diisocyanate compounds, for example having the general form Y(NCO)₂, with Y representing aromatic, alicyclic, and/or aliphatic groups (e.g., having at least 2, 4, 6, 8, 10 or 12 and/or up to 8, 12, 16, or 20 carbon atoms), for example a bivalent aliphatic hydrocarbon group having from 4 to 12 carbon atoms, a bivalent cycloaliphatic hydrocarbon group having from 6 to 15 carbon atoms, a bivalent aromatic hydrocarbon group having from 6 to 15 carbon atoms or a bivalent aryl-aliphatic hydrocarbon group having from 7 to 15 carbon atoms. Higher polyisocyanates can provide a higher degree of networking in the cured polymer (e.g., represented by Y(NCO)₃ or Y(NCO)₄ for 3 or 4 isocyanate groups, respectively, where Y is a trivalent or tetravalent group analogous to that above).

Examples of specific polyisocyanates include 1,5-naphthylene diisocyanate, 4,4′-diphenylmethane diisocyanate (MDI), hydrogenated MDI, xylene diisocyanate (XDI), tetramethylxylol diisocyanate (TMXDI), 4,4′-diphenyl-dimethylmethane diisocyanate, di- and tetraalkyl-diphenylmethane diisocyanate, 4,4′-dibenzyl diiso-cyanate, 1,3-phenylene diisocyanate, 1,4-phenylene diisocyanate, one or more isomers of tolylene diisocyanate (TDI, such as toluene 2,4-diisocyanate), 1-methyl-2,4-diiso-cyanatocyclohexane, 1,6-diisocyanato-2,2,4-trimethyl-hexane, 1,6-diisocyanato-2,4,4-trimethylhexane, 2-methyl-1,5-pentamethylene diisocyanate, 1-iso-cyanatomethyl-3-isocyanato-1,5,5-trimethylcyclohexane, chlorinated and brominated diisocyanates, phosphorus-containing diisocyanates, 4,4′-diisocyanatophenyl-perfluoroethane, tetramethoxybutane 1,4-diisocyanate, butane 1,4-diisocyanate, hexane 1,6-diisocyanate (or hexamethylene diisocyanate; HDI), HDI dimer (HDID), HDI trimer (HDIT), HDI biuret, isophorone diisocyanate (IPDI), trimer of isophorone diisocyanate (IPDI trimer), dicyclohexylmethane diisocyanate, cyclohexane 1,4-diisocyanate, ethylene diisocyanate, phthalic acid bisisocyanatoethyl ester, 1-chloromethylphenyl 2,4-diisocyanate, 1-bromomethylphenyl 2,6-diisocyanate, 3,3-bischloromethyl ether 4,4′-diphenyldiisocyanate, trimethylhexamethylene diisocyanate, 1,4-diisocyanato-butane, and 1,12-diisocyanatododecane.

Other classes of isocyanate compounds include reaction products of monomeric diisocyanates (e.g., such as via self-condensation, reaction of a few isocyanate groups with water, or other active H-compounds). This class of materials is generally referenced as a “polyisocyanate” by the skilled artisan. Yet another class includes isocyanate pre-polymers. These are the reaction products of a stoichiometric excess of isocyanate compounds (e.g., diisocyanates) with polyols, thus resulting in isocyanate-functional polyurethane oligomers.

In a particular refinement, the polyol includes a diol. The polyol is not particularly limited and generally can include any aromatic, alicyclic, and/or aliphatic polyols with at least two reactive hydroxyl/alcohol groups (—OH). Suitable polyol monomers contain on average 2-4 hydroxyl groups on aromatic, alicyclic, and/or aliphatic groups, for example having at least 4, 6, 8, 10 or 12 and/or up to 8, 12, 16, or 20 carbon atoms. In some embodiments, the polyol is a diol. In some embodiments, the polyol is a triol. Examples of specific polyols include one or more of polyether polyols, triethanolamine, hydroxlated (meth)acrylate oligomers (e.g., 2-hydroxylethyl methacrylate or 2-hydroxyethyl acrylate), glycerol, ethylene glycol, diethylene glycol, triethylene glycol, tetraethylene glycol, propylene glycol, dipropylene glycol, tripropylene glycol, 1,3-propanediol, 1,3-butanediol, 1,4-butanediol, neopentyl glycol, 1,6-hexanediol, 1,4-cyclohexanedimethanol, glycerol, trimethylolpropane, 1,2,6-hexanetriol, pentaerythritol, (meth)acrylic polyols (e.g., having random, block, and/or alternating hydroxyl functionalities along with other (meth)acrylic moieties), polyester polyols, and/or polyurethane polyols. The polyol can be biobased or made of synthetic feedstock. Examples of suitable biobased polyols include isosorbide, poly(lactic acid) having two or more hydroxyl groups, poly(hydroxyalkanaotes) having two or more hydroxyl groups, and biobased poly(esters) having two or more hydroxyl groups (e.g., as terminal groups).

In some embodiments, the UV-curable composition includes at least one tri- or higher functional polyisocyanate and/or at least one tri- or higher functional polyol, for example in addition to or instead of a difunctional polyisocyanate/polyol, Such tri- or higher functional monomers can promote crosslinking within the polyurethane segments of the polymeric composition, which is in addition to any crosslinking and/or network structure in the silane compound silane condensation products.

In some cases, the polyisocyanate is present in the UV-curable composition in an amount in a range from 5 wt. % to 25 wt. % based on the UV-curable composition; and the polyol is present in the UV-curable composition in an amount in a range from 5 wt. % to 70 wt. % based on the UV-curable composition. More generally, in various cases, the polyisocyanate can be present in the UV-curable composition in an amount of at least 5, 7, 10, or 15 wt. % and/or up to 10, 12, 15, 20, or 25 wt. % based on the UV-curable composition. Similarly, in various cases, polyol can be present in the UV-curable composition in an amount of at least 5, 10, 15, 20, 30, 40, or 50 wt. % and/or up to 15, 25, 35, 45, 55, 65, or 70 wt. % based on the UV-curable composition.

In many cases, the UV-curable composition further includes one or more additives. Suitable additives can include one or more of non-reactive fillers, reinforcements, mineral extenders, wetting agents, flow control agents, pigments (e.g., organic and/or inorganic), corrosion inhibitors (e.g., organic and/or inorganic). The corrosion inhibitor added to the mixture can be any suitable compound known for its corrosion-resistance and/or antioxidant properties. The presence of the corrosion inhibitor in the UV-curable composition mixture allows the inhibitor to be homogeneously dispersed in the eventual cured composition. In some cases, organic inhibitors are preferred over inorganic ones, as they generally have little or effect on the pH of the curing mixture, and it is desirable to carefully control the pH value in order to control the kinetics of the hydrolysis and condensation reactions in the mixture. Suitable organic inhibitors include heterocyclic organic compounds having 4 to 20 carbon atoms and one or more heteroatoms (e.g., N, O, S) along with anti-corrosion properties. Specific examples of suitable organic inhibitors include 8-hydroxyquinoline, benzimidazole, mercaptobenzothiazole, mercaptobenzimidazole, benzotriazole, and combinations thereof. The various additives individually or collectively can be included in the UV-curable composition in amounts of at least 0.1 wt. % or 1 wt. % and/or up to 3 wt. % or 5 wt. %. Alternatively or additionally, the various additives individually or collectively can be present in an amount such that its concentration in the 01H polymeric composition is at least 0.1 wt. %, 0.5 wt. %, or 1 wt. % and/or up to 3 wt. %, 5 wt. %, or 10 wt. %.

In many cases, the UV-curable composition is free from Michael-addition (MA) donor and Michael-addition (MA) acceptor compounds. In other cases, the UV-curable composition can include at least one of a Michael-addition (MA) donor and Michael-addition (MA) acceptor compound, for example as a secondary cure system. In some cases, the UV-curable composition can further include one or more components that undergo a Michael-addition reaction catalyzed by the photo-generated catalyst, for example components containing at least one MA-donor or MA-acceptor functional groups. Upon exposure of radiation, a Michael-addition reaction takes place independent of the silane crosslinking reaction, for example at a lower, equal, or faster reaction rate relative to the silane crosslinking reaction. In some cases, the MA compounds can be added to the UV-curable composition as separate compounds relative to the silane compound. In other cases, it is also possible that MA-donor or MA-acceptor functionality is incorporated into the organic part of the organosilane compounds, such that a covalently connected network including both siloxane crosslinks and MA reaction crosslinks is formed rather than an interpenetrating network of two separate materials.

Michael-Addition (MA) Acceptor Compounds: The Michael-addition (MA) acceptor compound is not particularly limited, and it suitably includes any compound having at least one MA acceptor functional group. In a refinement, the MA acceptor compound includes two or more MA acceptor functional groups. Suitably, the MA acceptor compound includes multiple MA acceptor functional groups for organic polymer chain propagation and/or crosslinking. For example, the MA acceptor compound can have at least 2, 3, 4, 6, 8, or 10 and/or up to 3, 4, 6, 8, 10, 12, or 15 MA acceptor functional groups.

In a refinement, the MA acceptor functional groups can include acrylate groups, methacrylate groups, vinyl groups, and combinations thereof. More generally, alpha-, beta-unsaturated compounds (e.g., including acrylates, methacrylates) and ketones are suitable MA acceptors. In a refinement, the MA acceptor functional groups includes blocked amine groups. As used herein, a “blocked amine group” refers to a moisture-blocked nitrogen-containing functional group that is reactive with water (e.g., as atmospheric moisture or otherwise) to form a corresponding amino group. For example, the blocked amine can be a ketimine compound or an oxazolidine compound, which can be substituted or unsubstituted. Unlike other MA acceptor functional groups, the blocked amine undergoes two sets of reactions with different kinetics. The first reaction (1), is the deprotonation of ambient moisture by the base catalyst to form an unblocked amine (e.g., a polyamino compound having at least 2, 3, 4, 6, 8, or 10 and/or up to 3, 4, 6, 8, 10, 12, or 15 amino or —NH₂ groups); and the second reaction (2), is the amine attack on the MA donor functional group. Another benefit of the selection of a blocked amine as the MA acceptor is that water generated via silanol condensation of the silane compound is used in the catalyzed hydrolysis of the blocked to form the corresponding unblocked amine, thus facilitating substantially complete through-curing of the coating without solely relying on ambient humidity or moisture for hydrolysis. Thus, as multiple layers are applied in rapid succession in a multilayer coating process or an additive manufacturing process, the internal layers that are no longer directly exposed to the external environment (i.e., and thus have less access to ambient moisture) still continue to cure due to available water from silanol condensation at internal locations of the applied layers. The differential kinetics of the two reactions has been observed such that (1) is very rapid and (2) is relatively slow. Systems capable of such differential kinetics can be very helpful as materials for additive manufacturing (3D printing material). In the layer-by-layer 3D printing process (Stereolithography or SLA), the system having plural-curing and differential kinetic capabilities have significant benefit. A thin layer of this system when exposed to UV radiation quickly solidifies via the rapid kinetic reaction providing strength to the film. This strength enables application of the second layer quickly. In the meantime, as layers are getting built up, the second slow kinetic reaction continue to form a matrix not only in its own layer (X-Y plane) but with also in the layer stacked over it (Z-direction). This will result in inter-layer crosslinking (covalent bonding), that will significantly increase inter-layer adhesion and the overall mechanical properties of the 3D printed product. Thus, such systems are very suitable for addressing one of the major challenges of SLA type 3D printing.

An example of a suitable acrylate MA acceptor functional group is R₁R₂C═CR₃—C(═O)O—. R₁, R₂, and R₃ can independently be selected from hydrogen (H), hydrocarbons containing from 1 to 20 carbon atoms, and heteroatom-substituted (e.g., N—, O—, P—, or S-substituted) hydrocarbons containing from 1 to 20 carbon atoms. The hydrocarbons and heteroatom-substituted hydrocarbons can be linear, branched, and/or cyclic, aliphatic and/or aromatic, saturated and/or unsaturated, etc., for example having at least 1, 2, 3, 4, 6, 8, or 10 and/or up to 2, 4, 6, 8, 10, 12, 15, or 20 carbon atoms. Selection of R₁, R₂, and R₃ as H corresponds to an acrylate/acrylic acid functional group. Selection of R₁ and R₂ as H and R₃ as CH₃ corresponds to an methacrylate/methacrylic acid functional group.

An example of a corresponding acrylate-based MA acceptor compound is [R₁R₂C═CR₃—C(═O)O-]ₘ-Hₐ. The index m can have a value or 1 (e.g., for a mono-functional acceptor) or 2 or more (e.g., for a poly-functional acceptor), for example being at least 2, 3, 4, 6, 8, or 10 and/or up to 3, 4, 6, 8, 10, 12, or 15. The Hₐ group as an organic core or body portion of the eventual cured composition can include hydrocarbons containing from 1 to 50 carbon atoms, and heteroatom-substituted (e.g., N—, O—, P—, or S-substituted) hydrocarbons containing from 1 to 50 carbon atoms. The hydrocarbons and heteroatom-substituted hydrocarbons can be linear, branched, and/or cyclic, aliphatic and/or aromatic, saturated and/or unsaturated, etc., for example having at least 1, 2, 3, 4, 6, 8, 10, or 20 and/or up to 2, 4, 6, 8, 10, 15, 20, 30, 40, or 50 carbon atoms.

In a refinement, the MA acceptor compound can include trimethylolpropane triacrylate (TMPTA), 1,6-hexanediol diacrylate (HDDA), dipropylene glycol diacrylate (DPGDA), pentaerythritol triacrylate (PETIA), and combinations thereof. The MA acceptor compound additionally can include polymeric or oligomeric compounds with (meth)acrylate functional groups and combinations thereof, for example including polymers or oligomers of the foregoing monomers. More generally, the MA acceptor compound can be an ester reaction product between (for example) an acrylic acid compound (e.g., R₁R₂C═CR₃—C(═O)OH with R₁, R₂, and R₃ as defined above) and a polyol Suitable polyols can include the same as those used in forming a polyurethane portion of the eventual cured composition. Similarly, the MA acceptor compound can be an urethane reaction product between (for example) a hydroxyalkyl-functionalized acrylic acid compound (e.g., R₁R₂C═CR₃—C(═O)OR′ with R₁, R₂, and R₃ as defined above and R′ being a hydroxyalkyl group with 1 to 10 carbon atoms, for example 2-hydroxyethyl) and a polyisocyanate Suitable polyisocyanates can include the same as those used in forming a polyurethane portion of the eventual cured composition. Other MA acceptor compounds can include acrylate-functionalized compounds such as polyester acrylates, (poly)urethane acrylates, etc.

An example of a suitable blocked amine MA acceptor functional group is a ketimine such as R₁R₂C═NR₃. R₁ and R₂ can independently be selected from hydrocarbons containing from 1 to 20 carbon atoms, and heteroatom-substituted (e.g., N—, O—, P—, or S-substituted) hydrocarbons containing from 1 to 20 carbon atoms. R₃ can be selected from hydrogen (H), hydrocarbons containing from 1 to 20 carbon atoms, and heteroatom-substituted (e.g., N—, O—, P—, or S-substituted) hydrocarbons containing from 1 to 20 carbon atoms. The hydrocarbons and heteroatom-substituted hydrocarbons can be linear, branched, and/or cyclic, aliphatic and/or aromatic, saturated and/or unsaturated, etc., for example having at least 1, 2, 3, 4, 6, 8, or 10 and/or up to 2, 4, 6, 8, 10, 12, 15, or 20 carbon atoms. Selection of R₁ and R₂ as CH₃ corresponds to a ketimine analog of acetone (e.g., formed by reaction of acetone with an R₃—NH₂ amine). Similarly, selection of R₁ and R₂ as CH₃ and C₂H₅, respectively, corresponds to a ketimine analog of methylethylketone (e.g., formed by reaction of methylethylketone with an R₃—NH₂ amine). Selection of R₃ as H corresponds to a primary ketimine. Selection of R₃ as hydrocarbons containing from 1 to 20 carbon atoms, and heteroatom-substituted (e.g., N—, O—, P—, or S-substituted) hydrocarbons containing from 1 to 20 carbon atoms corresponds to a secondary ketimine.

In a refinement, the MA acceptor compound can include one or more of a ketimine group and an oxazolidine group. The MA acceptor compound additionally can include polymeric or oligomeric compounds with blocked amine functional groups and combinations of a blocked amine group and other MA acceptor functional groups, for example including polymers or oligomers of the foregoing monomers.

Michael-Addition (MA) Donor Compounds: The Michael-addition (MA) donor compound is not particularly limited, and it suitably includes any compound having at least one MA donor functional group. In a refinement, the MA donor compound includes two or more MA donor functional groups. Suitably, the MA donor compound includes multiple MA donor functional groups for organic polymer chain propagation and/or crosslinking. For example, the MA donor compound can have at least 2, 3, 4, 6, 8, or 10 and/or up to 3, 4, 6, 8, 10, 12, or 15 MA donor functional groups.

In a refinement, the MA donor functional groups can include acetoacetate groups, thiol groups, and combinations thereof. More generally, nucleophiles, such as amines (e.g., aza-Michael addition, thiols (mercaptans), and acetoacetate-functional compounds are suitable MA donors.

An example of a suitable acetoacetate MA donor functional group is R₄C(═O)—CR₅R₆—C(═O)O—. R₄, R₅, and R₆ can independently be selected from hydrogen (R₅ and R₆ only), hydrocarbons containing from 1 to 20 carbon atoms, and heteroatom-substituted (e.g., N—, O—, P—, or S-substituted) hydrocarbons containing from 1 to 20 carbon atoms. The hydrocarbons and heteroatom-substituted hydrocarbons can be linear, branched, and/or cyclic, aliphatic and/or aromatic, saturated and/or unsaturated, etc., for example having at least 1, 2, 3, 4, 6, 8, or 10 and/or up to 2, 4, 6, 8, 10, 12, 15, or 20 carbon atoms. Selection of R₄ as CH₃ and R₅ and R₆ as H and corresponds to an unsubstituted acetoacetate functional group.

An example of a corresponding acetoacetate-based MA donor compound is [R₄C(═O)—CR₅R₆—C(═O)O-]ₙ-H_{d}. The index n can have a value or 1 (e.g., for a mono-functional donor) or 2 or more (e.g., for a poly-functional donor), for example being at least 2, 3, 4, 6, 8, or 10 and/or up to 3, 4, 6, 8, 10, 12, or 15. The H_{d} group as an organic core or body portion of the eventual cured composition can include hydrocarbons containing from 1 to 50 carbon atoms, and heteroatom-substituted (e.g., N—, O—, P—, or S-substituted) hydrocarbons containing from 1 to 50 carbon atoms. The hydrocarbons and heteroatom-substituted hydrocarbons can be linear, branched, and/or cyclic, aliphatic and/or aromatic, saturated and/or unsaturated, etc., for example having at least 1, 2, 3, 4, 6, 8, 10, or 20 and/or up to 2, 4, 6, 8, 10, 15, 20, 30, 40, or 50 carbon atoms.

In a refinement, the MA donor compound can include trimethylolpropane triacetoacetate (TMP-AA), 1,6-hexanediol diacetoacetate (HD-AA), dipropylene glycol diacetoacetate (DPG-AA), pentaerythritol triacetoacetate (PET-AA), and combinations thereof. The MA donor compound additionally can include acetoacetate-functionalized forms of polymeric polyols, such as polyester polyols, polyurethane polyols, polyether polyols, polyacrylate polyols. More generally, the MA donor compound can be an ester reaction product between (for example) an acetoacetate compound (e.g., R₄C(═O)—CR₅R₆—C(═O)OH or R₄C(═O)—CR₅R₆—C(═O)O-(t-C₄H₉) with R₄, R₅, and R₆ as defined above) and a polyol For example, t-butyl acetoacetate can be used to form transesterification products with polyols including a polyfunctional MA donor compound and t-butanol. Suitable polyols can include the same as those used in forming a polyurethane portion of the eventual cured composition.

Polymerization/Coating Process and Related Articles

As described above and illustrated in the figures, the UV-curable composition 100 is generally exposed to UV radiation 200 to generate (or form) a corresponding catalyst (e.g., acid or base catalyst) from the photo-latent catalyst initiator 120. The subsequently catalyzes the catalyst condensation of silanol groups formed from hydrolysis (e.g., also catalyzed by the catalyst) of the hydrolysable groups in the original silane compound 110, thereby forming an organic-inorganic hybrid (OIH) polymeric composition as a cured composition or coating 300 from the hydrolyzed and condensed silane compound 110. In some embodiments, for example when the UV-curable composition 100 includes a secondary curing system 140, the composition can represent a dual cure system. In such case, the silane compound 110 is typically a relatively faster-cure component, and the secondary curing system 140 is typically a relatively slower-cure component, such that cured composition or coating 300 can include both a condensed/crosslinked polymer 320 corresponding to the silane compound 110 and a secondary crosslinked polymer 330 corresponding to the curing system 140 components. In some embodiments, the UV-curable composition 100 can be applied to and cured on a substrate 410 to form a corresponding coated article 400. In the UV-curable composition 100 can be applied and cured in consecutive, patterned layers as part of an additive manufacturing process such that the final cured composition 300 has a desired/controlled (3D printed) shape.

In many cases, exposing the UV-curable composition to UV radiation includes irradiating the UV-curable composition with at least one of a mercury lamp and a UV-LED source. The irradiation source is not particularly limited, and any source with a characteristic spectral distribution in the UV-A and UV-B regions can be used, for example a standard medium pressure mercury lamp. A UV-LED source with wavelength ˜365 nm can also be used.

In many cases, providing the UV-curable composition in part (a) includes applying the UV-curable composition to a substrate prior to exposing the UV-curable composition to UV radiation; and exposing the UV-curable composition to UV radiation forms a coating of the OIH polymeric composition on the substrate. Suitably, the organic-inorganic hybrid (OIH) polymeric composition can form a protective coating on any of a variety of substrates, thereby providing a coated article. The uncured composition can be applied as a liquid mixture to the substrate and then exposed to UV radiation for curing, for example by spraying, dipping, etc. The film thickness should be such that, under a given type of UV-source, and cure process, UV-radiation should penetrate the entire film thickness. In such cases, it can be desirable to apply coatings in multiple application/curing steps to achieve a final desired thickness in a multilayer coating.

In some cases, the substrate includes a material selected from the group consisting of metals (e.g., steel), alloys thereof, thermoplastic materials, thermoset materials, composite materials, primer materials, glass, wood, fabric, and ceramic materials. In other cases, the substrate includes aluminum. The substrate more generally can include any material other than a cured OIH composition, or it can include a material with a top layer of a cured OIH composition thereon. The substrate is suitably a metallic substrate. In this case, the OIH polymeric composition forms a coating that serves to reduce or prevent corrosion of the underlying metallic substrate from ambient environmental conditions. In various cases, the substrate can be a metal (e.g., aluminum), a metal alloy (e.g., an aluminum-containing alloy), or a non-metal. In some cases, the OIH polymeric composition is adhered to the substrate via covalent linkages. Many metal substrates (M), including aluminum (Al), contain surface-bound hydroxyl groups (e.g., M-OH or Al—OH, either present natively or after surface preparation by conventional techniques) that themselves can condense during cure with silanol groups in the hydrolyzed silane compound to release water and form an adherent, covalent linking functional group between the metal substrate and the cured silane compound (e.g., [polymer coating]-SiOM-[metal substrate] or [polymer coating]-SiOAl-[aluminum substrate]).

In some cases, the coating has a thickness in the range of 2 μm to 100 μm. More generally, the coating can have any desired thickness, for example in the range of 1 μm to 100 μm. For example, the coating can be at least 1, 2, 5, 10, 15, or 20 μm and/or up to 5, 10, 20, 30, 40, 50, 60, 80, or 100 μm. Even thicker films can be obtained by manipulating coating composition and/or increasing the number of applied layers. In general, the coating thickness of a single layer can be controlled primarily by the solids loading of the UV-curable composition (or application bath), and to some extent by the viscosity of the composition. The solids content of the UV-curable composition generally includes all non-volatile components (e.g., components other than those which evaporate after application to a substrate, such as organic, aqueous, or other solvents), for example primarily including the silane compound and any other crosslinking resin components, but also including non-reactive fillers, residual catalyst, etc. For example, the dry film thickness (DFT) of a cured OIH polymeric composition can be about 2-3 μm or 2-4 μm for a solids content of about 10 wt. % (or about 8-15 wt. %), about 4-6 μm or 3-8 μm for a solids content of about 20 wt. % (or about 15-30 wt. %), about 8-12 μm or 6-15 μm for a solids content of about 30 wt. % (or about 20-40 wt. %), and about 20 μm, 15-25 μm, or 12-30 μm for a solids content of about 40 wt. % (or about 30-50 wt. %).

In some cases, the method further includes applying a topcoat layer over the coating (i.e., as already applied to a substrate and/or cured). In some cases, the coated article with an OIH polymeric composition coating optionally can include a polymeric primer layer and/or a polymeric topcoat layer as additional layers providing barrier/sealant/anti-corrosion properties. The primer layer can be coated on an outer surface of the OIH polymeric composition coating (e.g., the surface opposing that to which the substrate is adhered). Similarly, the topcoat layer is coated on an outer surface of the primer layer (e.g., the surface opposing that to which the OIH polymeric composition coating is adhered). In some cases, the primer layer is not present, and the topcoat layer can be coated on the outer surface of the OIH polymeric composition coating (e.g., directly thereon). In addition to providing anti-corrosion properties, the polymeric primer layer additionally promotes adhesion between the OIH polymeric composition coating and the topcoat layer. Such polymeric coatings are suitably chromium-free (e.g., free from hexavalent chromium, trivalent chromium, and/or chromium in any other form). Suitable polymeric materials for the primer and topcoat are generally known and are not particularly limited, with specific examples including epoxy-, polyester-, polyurethane-, polyurea-, and acrylic-based coatings (e.g., where the primer and topcoat suitably have the same or similar base polymeric character, such as polyurethane- or polyurea-based primers/topcoats having hydrogen-bonding donor/acceptor groups for improved wetting and adhesion properties relative to the OIH polymeric composition coating). In a many cases, the topcoat layer includes a further OIH polymer composition layer. For example, the topcoat layer applied over an existing OIH polymer coating can be another layer (or several other layers) of the same or different OIH polymer composition. Such additional layers of OIH polymer compositions can be used in an additive manufacturing process, for example a sterolithography (SLA) additive manufacturing (or 3D printing) process in which the OIH polymer composition serves as the additive manufacturing material. Subsequent layers of the OIH polymer composition can have selected sizes/shapes to provide a desired overall shape of the final additive manufacturing article.

FIG. 6 illustrates coated article 400 according to the disclosure including a substrate 410, a cured OIH coating 300, an optional primer layer 420, and an optional topcoat layer 430. The coated article 400 includes a substrate 410 having a cured compound 300 as a coating on a surface (e.g., outer surface) of the substrate 410. The cured coating 300 can include a condensed/crosslinked polymer 320 corresponding to the silane compound 110 and (optionally) a secondary crosslinked polymer 330 corresponding to the curing system 140 components. The cured coating 300 (e.g., as formed by the above method) suitably has a thickness or at least 1 μm or 2 μm, for example ranging from 1 μm or 2 μm to 5 μm or 10 μm for a single coating application, and multiple coatings applied/cured in series can form a correspondingly thicker coating 300 if desired, for example up to 100 μm as described above.

In an extension, the coated article 400 optionally can include a polymeric primer 420 layer and/or a polymeric topcoat 430 layer as additional layers providing barrier/sealant/anti-corrosion properties. As illustrated in FIG. 6, the primer layer 420 is coated on an outer surface of the cured coating 300 (e.g., the surface opposing that to which the substrate 410 is adhered). Similarly, the topcoat layer 430 is coated on an outer surface of the primer layer 420 (e.g., the surface opposing that to which the cured coating 300 is adhered). When the primer layer 420 is not present, the topcoat layer 430 can be coated on the outer surface of the cured coating 300. In addition to providing anti-corrosion properties, the polymeric primer layer 420 additionally promotes adhesion between the cured coating 300 and the topcoat layer 430. Such polymeric coatings are suitably chromium-free (e.g., free from hexavalent chromium, trivalent chromium, and/or chromium in any other form). Suitable polymeric materials for the primer and topcoat are generally known and are not particularly limited, with specific examples including epoxy-, polyester-, polyurethane-, polyurea-, and acrylic-based coatings (e.g., where the primer and topcoat suitably have the same or similar base polymeric character, such as polyurethane- or polyurea-based primers/topcoats having hydrogen-bonding donor/acceptor groups for improved wetting and adhesion properties relative to free hydrogen-bonding groups in the cured coating 300).

The disclosure additionally relates to a method of additive manufacturing, the method including: applying a first layer of an additive manufacturing component; applying an organic-inorganic hybrid (OIH) polymeric composition according to any of the variously disclosure refinements on the first layer; and applying a second layer of an additive manufacturing component on the OIH polymeric composition. The first layer and the second layer likewise can be OIH polymer composition layers. Subsequent layers of the OIH polymer composition can have selected sizes/shapes to provide a desired overall shape of the final additive manufacturing article.

While the disclosed compounds, methods, and compositions are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### EXAMPLES

Examples 1-3 illustrate organic-inorganic hybrid (OIH) polymeric compositions, related FOIH polymeric compositions, and related methods of making the same according to the disclosure.

### Example 1

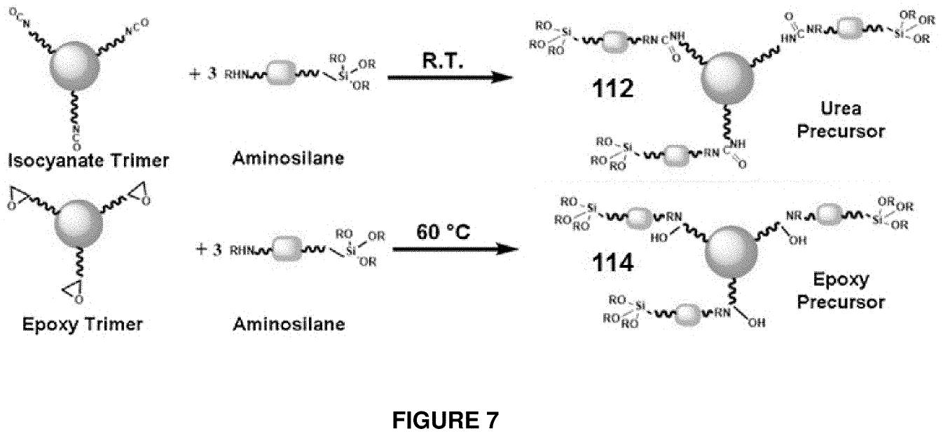

In this example, a UV-initiated curing mechanism (UV-sol-gel) was used in order to obtain a polymerized network of Si—O—Si on an aluminum substrate. This technique uses UV-radiation to trigger the sol-gel process by the in-situ generation of superacid or superbase catalysts to decrease or increase the pH of hydrolysis and condensation environment. As illustrated in FIG. 7, the pretreatment system used hydrolysable silane compounds including a polyureasil or urea precursor 112 and a polyepoxy or epoxy precursor 114, each with a 9 hydrolysable silyl groups per precursor molecule. The corresponding UV-curable composition included one of the precursors 112, 114, photo-acid generators (PAG) or photo-base generators (PBG), and an organic solvent. The precursors were synthesized by modifying polymeric intermediates using functional alkoxysilane compounds. The precursors and cured films were characterized using fourier transform infrared (FTIR), proton nuclear magnetic resonance (1H-NMR), contact angle, and gravimetrical techniques. The performance of UV-sol-gel pretreatments was evaluated for corrosion resistance using quantitative techniques such as DC polarization and electrochemical impedance spectroscopy (EIS) along with the salt spray test (ASTM B117). The effects of precursor chemistry, catalyst type, and thermal post-treatment were studied in comparison with the conventional wet process. The effect of various factors such as UV light intensity and coating thickness was investigated on the coating's anti-corrosion performance. Finally, the possibility of using a functionalized OIH pre-treatment with a relatively higher thickness (25±5 μm) in a primer-less protective coating system was evaluated using EIS and salt spray methods.

Materials: Aluminum alloy (Al 2024-T3) and iron phosphated cold-rolled steel (CRS) test panels with dimensions of 5×5, and 7×14 cm were used. Isocyanurate trimer of Hexamethylene diisocyanate with NCO content of 21.8% and chemical name of 1,3,5-tris(5-isocyanatopentyl)-1,3,5-triazinane-2,4,6-trione (VESTANAT 2500HT) and N-(n-butyl)-3-aminopropyltrimethoxysilane with molecular weight of 235.4 (DYNASYLAN1189) were used (Evonik Industries, USA). Tris(4-hydroxyphenyl)methane triglycidyl ether epoxy compound (EPALLOY 9000, molecular weight=510) was used (CVC performance materials, USA). Photo-blocked 1, 5 diazabicyclonon-5-ene (DBN) with the commercial name of CGI-90 and (4-Methylphenyl) [4-(2-methylpropyl)phenyl] iodonium hexafluorophosphate (IRGACURE 250) were used as PBG and PAG, respectively (BASF, USA). 2-isopropylthioxanthone (ITX) was also used as a photo-sensitizer in conjunction with the photo-initiators. Ethanol, n-butanol, acetone, tetrahydrofuran(THF), acetic acid, and sodium chloride were purchased from Sigma-Aldrich. Brulin 815 GD, a proprietary detergent, was used (Brulin & Company Inc.). Hexamethylene diisocyanate based polyisocyanates (DESMODUR N 3390A; Covestro) and hydroxyl functional acrylic oligomer (JONCRYL 924; BASF) were used as a 2-component polyurethane topcoat. Titanium oxide (TI-PURE R670) was used (DuPont, USA). All the materials used had at least a reagent grade (>95%) purity.

Precursor Synthesis and Characterization: Two different precursors were synthesized by reaction of DYNASYLAN 1189 with VESTANAT 2500HT and EPALLOY 9000, respectively. The precursors resulting from the reaction with isocyanate and epoxy compounds were labeled as Urea and Epoxy precursors, respectively.

Urea Precursor: The calculated amount of DYNASYLAN 1189 was dissolved in THF solvent and was added into a three-neck flask equipped with a mechanical stirrer, nitrogen inlet, temperature controller probe, and water condenser setup. The NCO functional compound in a 1:1 equivalent ratio to amine groups was then added to the flask dropwise. Due to the exothermic nature of the reaction, the reaction temperature was controlled at room temperature using an ice bath. The progress of reaction was tracked by amine value titration as per ASTMD 2074, NCO content as per ASTMD 2572, and also FTIR spectroscopy.

The NCO value and amine value obtained by titrations, dropped by more than 98% of their initial values after 3 h of reaction. This indicated the quantitative yield of this reaction to obtain the precursor with more than 98% purity. Moreover, the FTIR spectra of the reaction mixture before and after 3 h of the reaction time showed the disappearance of the peak at 2273 cm⁻¹, which is attributed to the NCO stretching of the isocyanate compound. The peaks at 2800-2900 cm⁻¹ (C—H stretching), 1760 cm⁻¹ (C═O stretching), 1639 cm⁻¹ (N—H stretching) and 1087 cm⁻¹ (Si—O—R stretching) remained unchanged [37].

The appearance of the corresponding proton peak of NH moiety in urea functional group (4.6-4.7 ppm) and absence of the 2 ppm peak related to NH groups of the DYNASYLAN 1189 in ¹H-NMR spectrum of the isolated Urea precursor, was also another indication of the formation of urea linkages as a result of the reaction [38]. After the reaction, the THF solvent was then removed by vacuum distillation and replaced with ethanol at 65 wt. % of solids.

Epoxy Precursor: The calculated amount of EPALLOY 9000 was added into a three-neck flask equipped with a mechanical stirrer, nitrogen inlet, temperature controller probe, and water condenser setup. After adding THF to the flask and dissolving the epoxy, Dynasylan1198 was added into the flask while stirring (1:1 eq. ratio of amine hydrogen equivalent weight and epoxy) and temperature was set to 60° C. The progress of the reaction was tracked by FTIR method and the modified oxirane oxygen content (OOC %) titration as per ASTMD 1652 (after removing the contribution of amines).

After 3 h of reaction time, the OOC % reduced by >97% of the theoretically expected value, which could be an indication of almost quantitative reaction yield and high purity of the product. The FTIR analysis revealed that the weak mid-range peak at 907 cm⁻¹, which is attributed to the C—O—C stretching of epoxide, disappeared after 3 h of reaction time. The 907 cm⁻¹ peak was overlapped with 915 cm⁻¹ peak, which could be related to the stretching vibration of Si—O—R groups. However, the transition from an overlapped peak to a single distinct one at 915 cm⁻¹ was still clearly seen. The emergence of the broad 3300-3500 cm⁻¹ peak related to the stretching of OH groups was detected as a result of the ring-opening of oxirane rings. The peaks at 2800-2900 cm⁻¹ (C—H stretching), 1639 cm⁻¹ N—H stretching), and 1087 cm⁻¹ (Si—O—R stretching) were also detected.

Diminishing of peaks corresponding to the protons of the oxirane ring (3.15-3.24 and 2.6-2.87 ppm) and appearance of the peak at 3.8-3.9 ppm, which could be related to the CH group adjacent to the produced hydroxyls, were also detected by the ¹H-NMR spectrum of ¹H— NMR spectra of the Epoxy precursor containing the corresponding the isolated Epoxy precursor. The synthesized precursor was stored in a well-sealed container at 65 wt. % of solids in the solvent. Due to the high reactivity of alkoxy silane groups present in both precursors, no additional purification was done before their use in the coating composition.

Preparation and Application: The aluminum alloy panels were degreased and chemically etched before the application of pretreatments. For the wet sol-gel process, considering a total of 350 g of application bath, 70 g of the precursor was mixed with 134.20 g of ethanol, and 94.2 g of DI water. In order to adjust the pH to ˜4, 22.8 g of acetic acid was then added. The total precursor concentration was 20 wt. %. The mixture was stirred for 3 h before the application. For UV sol-gel process, 70 g of the precursor was mixed with 278 g ethanol/THF solvent, and 2.1 g (3 wt. % of solids) of photo-latent catalyst (PBG or PBG) together with 0.53 g of ITX was added to reach the total weight of 350 g at 20 wt. % of precursor concentration. All pretreatments were applied at room temperature (25-30° C.) and at the relative humidity of 50±5% using an automatic dipcoater (PTL-200, MTI Corporation), at an immersion/withdrawal speed of 17 cm/min, with a residence time of 15-20 s. After application, the panels were placed vertically in a panel stacker for 15 min of air drying. In the case of the dry sol-gel process, panels were passed 3 times under a Fusion UV system with an H-bulb (LoctiteZETA7415) with the conveyor belt speed set to 12 feet/min and light intensity of ˜0.70 J/cm².

In addition to varying precursor type and processing method (superacid, superbase, and wet), some test panels were placed in an oven for 30 min to investigate the effect of thermal post-treatment. Samples were all tested after 7 days of storage at room temperature. The typical dry-film thickness obtained was ˜7-8 microns, as measured by scanning electron microscope (SEM) images. For topcoats, DESMODUR N 3390A (isocyanate) and JONCRYL 924 (polyol) were mixed in a 1:1 equivalent ratio to form a standard polyurethane (PU) and also a non-isocyanate polyurethane coating sample was used. Topcoats were formulated with 10% pigment volume concentration (PVC) of TiO₂ and applied using a draw-down applicator to achieve dry film thickness of 75±5 microns.

Test Methods: FTIR and attenuated total reflection (ATR)-FTIR spectra were collected using KBr standard disks on Bruker instrument at 64 scans and 2 cm⁻¹ of resolution. The spectra obtained in the frequency range of 400-4000 cm⁻¹ were used to evaluate the chemical structure of the end products. ¹H— NMR spectroscopy measurements were performed on a JEOL 400 MHz multiple nucleus spectrometer using chloroform-d solvent and tetramethylsilane as the internal standard. The contact angle test was carried out using an FTA-200 dynamic contact angle analyzer with a tilt-stage and environmental chamber. For gravimetrical analyses, the weight measurements were carried out using a Veritas analytical balance with an accuracy of 0.1 mg. MINITAB software was used for the analysis of variance among weight measurements.

The anti-corrosion properties of the specimens were studied and analyzed using DC polarization and EIS techniques through a Gamry PCI300 potentiostat connected to a three-electrode setup (PTC1) consisting of a saturated calomel electrode (SCE) as a reference electrode, graphite rod as a counter electrode, and coated test specimen as a working electrode. For each sample, an area of 1 cm² was exposed to 3.5% NaCl solution as test electrolyte. EIS was performed in the frequency range of 0.02-10 kHz using a frequency response analyzer. DC polarization curves were obtained at a scan rate of 1 mV/s in the applied potential range of ±200 mV from open circuit potential. The results were analyzed using the GAMRY ECHEM ANALYST software. Three replicates were carried out for electrochemical tests. Since the standard deviation of the measurements (after excluding the outliers) was low, the average values were reported. Samples were also subjected to the salt spray test conditions according to ASTMB 117 up to 300 h and 1000 h for pretreatments and samples with pretreatment and topcoat, respectively. The samples were then evaluated for the degree of blistering by comparison with the photographic reference standards (ASTM D714) and also the representative mean creepage of corrosion products or loss of coating extending from a scratch mark was rated based on the prescribed table (ASTMD1654).

Curing Characterization: For both conventional (wet) sol-gel and UV-sol-gel process, the curing reaction mainly involves the conversion of alkoxy silane groups to a cross-linked siloxane network (OIH). FTIR spectroscopy was used to track the conversion of alkoxy silane groups to siloxane network. A representative ATR-FTIR spectrum, for the UV-sol-gel system containing the Urea precursor and PBG after post-treatment and storage at room temperature for 7 days was compared to the precursor's FTIR spectrum. It was observed that a sharp and intense peak at 1087 cm⁻¹ for the precursor sample before UV-curing (related to Si—O—R groups) transformed into distinct peaks at around 980 cm⁻¹, 1050 cm⁻¹, and 1150 cm⁻¹ indicating substantial conversion of alkoxy silane groups. The separate peaks in the range of 1000 to 1250 cm⁻¹ are generally expected to arise mostly from asymmetric stretching vibrations of Si—O—Si bridging sequences. Moreover, the peak at 915 cm⁻¹ associated with Si—O—R groups disappeared in the spectra of the cured film.

In the presence of the photo-latent PBG, which is a non-ionic photo base generator that releases DBN upon UV exposure, an in-situ increase in pH triggers the formation of silanols under ambient humidity and their condensation in a relatively short time. A similar trend was also observed in the pretreatment formulation containing PAG. In that case, in-situ decomposition of a diaryliodonium salt and an α-aminoketone leads to the generation of a super acid compound containing H⁺, PF₆—, and tertiary amine which act as efficient condensation catalyst. In addition to the PAG and PBG effect, the addition of a photo-sensitizer (ITX) can increase the absorption probability in a broader range of UV and, therefore, increase the efficacy of the photo-latent catalysis.

Gravimetrical Analyses: This example examiners difference between the curing extent and performance of pretreatments containing PAG and PBG in comparison with the conventional wet sol gel method. Moreover, for UV-sol-gel systems, the effect of additional thermal post-curing on the performance of these systems was evaluated, as compared to the conventional system. Therefore, various samples in this example examine the extent of conversion of alkoxy silane groups in UV-sol-gel pretreatments without any heat post-curing (samples designated as “R”) and their post-cured counterparts (samples designated as “O”).

Since the cure reactions primarily involve the formation of a specific amount of alcohol and water (volatile loss) corresponding to the alkoxy silane content of the system, a gravimetric method was used for characterization of the cure extent. The initial weight of the coatings on test panels (after solvent flash-off) as well as the weight of coating after UV exposure and post-treatment (either O or R), and the coating weights after 7 days of storage were recorded using an analytical balance (four replicates each) and the effect of catalyst system (photo-latent base or acid) and post-treatment on the observed weight loss was analyzed using statistical software. The main effect diagrams and analysis of variance (ANOVA) results obtained from MINITAB software for weight loss difference immediately after curing and post-treatment show that the effect of catalyst type on weight loss in comparison with the wet process was not statistically significant for both types of precursors (P=0.928 and P=0.081 for Urea and Epoxy precursors, respectively). This suggests that the extent of curing in formulations containing photo-latent catalysts is as much as that of the conventional wet process, and the mean value of weight loss is even more in UV-sol-gel systems. This effect was more pronounced for the Epoxy precursor as the acid catalyzed systems had higher weight loss value.

The results indicated that thermal post-treatment had a significant effect on the extent of curing in all samples (especially for Urea precursor), as the differences in weight loss values between the samples, with and without thermal treatment, was statistically significant (P=0.04 and P=0.06 for Urea and Epoxy precursors, respectively). This suggests that, regardless of the catalyst type and curing mechanism, additional heat treatment would accelerate the curing process-which has been initiated by the release of super base or super acid after UV exposure, leading to a higher weight loss value immediately after curing.

Based on the weight loss values of the samples after 7 days of storage under ambient conditions after exposure to the UV source, the data show that although samples with post-treatment (O samples) still had higher weight loss, the effect of post-treatment was not statistically significant anymore (P=0.325 and P=0.108 for Urea and Epoxy precursors, respectively) as the weight loss values had increased for R samples of UV-sol-gel systems. On the other hand, the effect of the catalyst was found to be more significant (P=0.51 and P=0.02 for the Urea and Epoxy precursors, respectively) because unlike wet sol-gel samples, the mean weight loss for acid and base catalyzed UV-sol-gel sample increased substantially after 7 days at room temperature. These results suggest that in the case of UV-sol-gel samples, the condensation reaction would continue for an extended time after UV exposure (dark cure) and reach to the level of thermal post-treated samples. This can be ascribed to the presence of an active catalyst in these systems, driving the condensation reaction. This observation also suggests that UV-sol-gel samples will attain performance comparable to thermal post-cured samples within 7 days under ambient conditions, and hence do not require thermal post-treatment. This is a significant technical and environmental benefit of UV-sol-gel pretreatments.

Contact Angle Measurement: One effect of the sol-gel pretreatments on various substrates is an increase the surface hydrophobicity, which could lead to better protection of the substrate from the corrosive environment and water penetration. Contact angle measurements were made to examine the effect of UV-sol-gel pretreatments on surface energy. Contact angle values were obtained from pretreatments with different precursor types, application processes, and post-treatment combinations. Table 1 summarizes the mean value of the contact angle from the three replicates was considered. In Table 1, samples are labeled in the order of (i) precursor type (Urea or Epoxy), (ii) application process (A for PAG, B for PBG, and W for the wet process), and (iii) post-treatment type (R for room temperature storage and O for thermal post-treatment). For example, a sample with a combination of “Urea-A-O” represents a pretreatment system based on Urea precursor that has been cured by a photo-latent photo acid generator (PAG) followed by an additional thermal post treatment.

TABLE 1
Cured Coating Properties

| | Urea | | | | | | Epoxy | | | | | | |
|---|---|---|---|---|---|---|---|---|---|---|---|---|---|
| | A | A | B | B | W | W | A | A | B | B | W | W | Bare |
| Sample | R | O | R | O | R | O | R | O | R | O | R | O | Metal |
| Contact Angle (°) | 73.9 | 74.5 | 68.6 | 77.8 | 72.4 | 80.8 | 80.4 | 82.8 | 77.6 | 84.0 | 71.0 | 78.2 | 62.2 |
| Icorr (μA/cm²) | 0.2 | 0.28 | 0.67 | 0.57 | 1.16 | 0.17 | 0.2 | 0.08 | 0.13 | 0.11 | 0.75 | 1.31 | 298 |
| Ecorr (mV) | −663 | −630 | −691 | −676 | −556 | −599 | −594 | −605 | −615 | −592 | −608 | −584 | −1207 |
| \|z\| at 0.02 Hz | 14.9 | 22.8 | 11.0 | 12.3 | 7.8 | 34.6 | 127 | 175 | 23.0 | 24.9 | 11.1 | 16.2 | 0.11 |
| (kOhm)* | | | | | | | | | | | | | |
| Rpore (kOhm) | 15.8 | 24.6 | 10.3 | 12.0 | 10.4 | 31.5 | 125 | 148 | 22.3 | 26.8 | 11.9 | 15.2 | 0.09 |

*Impedance values normalized per cm².

As shown in Table 1 all samples showed a significant improvement in contact angle value from that for the bare metal surface (62.2°), which indicates an effective increase in surface hydrophobicity of the pretreated panels. It was also observed that for almost all samples, the contact angle was higher for thermally post-treated samples. However, the difference in values was significantly higher for wet systems compared to UV-sol-gel pretreatment samples. This could imply the presence of more Si—O—Si linkages for UV-sol-gel pretreatments, even without the thermal post-treatment. The highest contact angle value was achieved for the Urea-A-O sample with a value of 82.8°.

Anti-Corrosion Properties: The effect of precursor type, application and curing process, and post-treatment on anti-corrosion properties of pretreated Al substrates was evaluated using DC polarization, EIS, and salt spray techniques. All samples were applied at approximately 7 microns of dry film thickness. After UV exposure (and thermal post-treatment for O samples), the samples were stored at room temperature for 7 days and were then exposed to a corrosive environment. Quantitative data resulting from DC polaraization and Tafel extrapolation are also summarized in Table 1, including corrosion current density (lcorr; μA/cm²) and Ecorr (mV) values, using the same sample code identifiers noted above.

For all coating compositions, a significant reduction in corrosion current density (lcorr) was achieved in comparison with bare metal (lcorr=298 μA/cm²). Additional thermal post-treatment had a positive effect on the corrosion resistance of pretreated samples across all the formulations. However, the difference between the performance of O and R samples was significantly less for UV-sol-gel systems compared to that of the wet process. This is consistent with the findings of contact angle measurement and suggests that for UV-sol-gel samples, a thermal post-treatment is not required if there is sufficient time between the UV curing and testing. In these systems, once the superbase or superacid is generated after UV exposure, the sol-gel condensation reactions (cure reaction) would continue even in the absence of UV radiation (dark cure) for a considerable time leading to very high extent of crosslinking. However, in the case of a conventional wet sol-gel process that extent of curing, and hence film performance is significantly dependent on hydrolysis of silanes in aqueous application bath, incomplete hydrolysis before dipping of panels in the application bath could lead to an insufficient degree of curing. Conversely, if the application is done from the bath that has passed its optimum shelf-life (partial conversion of sol to gel in the bath) inferior degree of curing will result. This deficiency in a conventional wet sol-gel process could only be compensated by thermal post-treatment to facilitate a higher extent of curing.

Another point observed from the results is the fact that corrosion current densities were significantly lower for pretreatments based on the Epoxy precursor compared to the Urea precursor. The lcorr value for the Epoxy-A-O sample was as low as 0.08 μA/cm², while the value for the counterpart Urea system (Urea-A-O) was 0.28 μA/cm². This indicates the dependence of corrosion performance on the pre-cursor chemistry. For urea-based samples, the wet process with post-treatment still possessed the lowest lcorr values, while the best combination in Epoxy systems (Epoxy-A-O) outperformed all other samples.

Table 1 also summarizes the results from EIS measurements for pretreated samples based on Urea and Epoxy precursors, respectively, after 7 days of immersion in 3.5 wt. % NaCl solution, including impedance values (|z| at 0.02 Hz; kOhm) and Rpore (kOhm) values, using the same sample code identifiers noted above. The impedance values at low frequencies (|z| at 0.02 Hz) is a good indicator of total resistances in a coating system [461. In addition to that, Rpore values, which are attributed to the coating layer's resistance against corrosion media, were calculated by fitting the results with an appropriate equivalent circuit.

Similar trends of values were observed in EIS as the pretreated samples based on the Epoxy precursor showed significantly better performance compared to the Urea systems. The Epoxy-A-O sample had the highest impedance and Rpore values (175 and 148 kOhm, respectively), which outperformed the samples obtained by the conventional wet process by a large margin. Inferior properties of Epoxy-W samples could be due to partial incompatibility of the Epoxy precursor with water as the main element of the wet process. It was also observed that PAG-containing samples performed slightly better in general.

Effect of UV Light Intensity: To evaluate the effect of UV light intensity on the curing and performance of the pretreated samples, a representative pretreatment system sample was exposed to two significantly different levels of UV light intensity. A series of samples was exposed to a total UV light intensity of 2.94 j/cm² while the other series (High Intensity samples) were exposed to a total of 12.15 j/cm². DC polarization and EIS results were obtained after 7 days of immersion in 3.5 wt. % NaCl. Results indicated that samples exposed to higher UV light intensity performed significantly better compared to the ones exposed to low UV intensity (Epoxy-A samples), with or without thermal post-treatment. The lcorr and |z| at 0.02 Hz value for Epoxy-A-R sample exposed to higher UV energy was 1.8 nA/cm² and 294 kOhm, which was improved compared to that of Epoxy-A-O sample.

This significant improvement in properties can be attributed to the generation of an increased amount of the superacid catalyst and also to the generation of more heat (IR component of the emission spectrum of UV lamp) accelerating the cure reaction. The samples exposed to higher UV intensity were simultaneously exposed to the heat generated by IR. However, the performance for Epoxy-A-R sample exposed to high UV intensity was even better than the one with post-treatment but cured with lower UV intensity. Therefore, the results suggest that the synergic effect of higher UV intensity and heating could result in a higher degree of cure and better corrosion resistance compared to samples only ex-posed to heat post-treatment or higher UV intensity. For comparison, the typical lcorr value for a commercial Cr (VI) based pre-treated Al has been reported to be around 1-4 μA/cm².

Effect of Film Thickness: The effect of an increase in the thickness of the pretreatment layer was investigated by applying a three-fold thicker sample by immersion in 60 wt. % solution of Epoxy-A formulation. The resulting film thick-ness of the “Epoxy-A-O (High thickness)” sample was measured around 25±5 μm. EIS and salt spray results demonstrated a significant improvement in anti-corrosion properties of the OIH layer as a capacitive behavior was observed from Epoxy-A-O (High thickness) sample in bode diagram indicating that no further diffusion of corrosive elements occurred after 7 days of immersion in 3.5 wt. % NaCl solution. The salt spray test also demonstrate the superior performance as almost no sign of blistering or growth of the corrosion products across the scratch line was observed after 300 h of exposure time.

Primer-less Coating Systems: One of the significant advantages of the UV-sol-gel pretreatment process is the decoupling of application bath stability from the concentration of precursor in the application bath. Unlike in conventional (wet) systems, the application bath in the UV-sol-gel system is not active until exposure to the UV source. This is a significant technical benefit that enables the use of higher precursor concentrations. The higher precursor concentration will result in thicker films and hence, better corrosion performance. A relatively thicker (about 25 μm) layer of the OIH layer with desirable barrier properties and excellent adhesion to the subsequently applied organic layer through intermolecular interactions, could allow formulation of protective coating systems without the need for a primer layer.

To demonstrate the possibility of using the UV-sol-gel pretreatment systems in primer-less coating systems, a pretreatment sample (Epoxy-A-O) was applied on cold-rolled steel (CRS) and Al 2024-T3 substrates from a bath with 60 wt. % of precursor concentration followed by application of a commercial PU or NIPU organic coating layers. The coating systems were studied for their anti-corrosion properties using the salt-spray test (ASTM B117) and EIS technique. EIS measurements were made for the primer-less coating system after 4 weeks of immersion time in 3.5 wt. % NaCl. The |z| at low frequencies for the primer-less coating sample containing OIH pre-treatment (|z| at 0.02 Hz=774 Mohm) was in a comparable range with respect to a typical 3-layer system (phosphate conversion coating+epoxy primer+PU topcoat) which is a very common system used in industrial coating applications. Moreover, salt spray results also revealed that the selected primer-less coating system performed just as well as a 3-layer one after 1000 h of exposure. The results were consistent for both NIPU and standard PU topcoats and on different substrates (i.e., CRS and Al 2024-T3). This could be an advantage for these types of OIH coating systems leading to a significant reduction in time, workforce, and material consumption.

Summary: In this example, a UV-initiated sol-gel process was illustrate for the deposition of organic-inorganic hybrid pretreatments, and its suitability and superiority over the conventional sol-gel process was demonstrated. The use of suitable photo-latent superacid or photo-latent superbase as a catalyst for the sol-gel reaction of organosilane precursors led to the formation of the OIH network upon exposure to a suitable UV source under ambient humidity conditions. Both catalysts were found to catalyze the UV-sol-gel process effectively and showed a comparable cure extent. A gravimetric method was devised for cure characterization was found to corroborate well with FTIR characterization and water contact angle measurements. A comparison of OIH pretreatments derived from the UV-sol-gel process was made with the conventional wet sol-gel process to understand the unique benefits and limitations of the UV-sol-gel process. The results indicated that the extent of curing and corrosion resistance of UV-sol-gel systems can be tailored by choice of alkoxysilane precursor, type of photo-latent catalyst, UV light intensity, and dry-film thickness. The extent of curing, and hence corrosion resistance performance of UV-sol-gel pre-treatments, could be improved by using higher UV light intensity. Furthermore, UV-sol-gel pretreatments attain the very high extent of curing (comparable to that of thermal post-treated samples) within 7 days at ambient temperature, avoiding the need for expensive thermal post-treatment. Another significant technical benefit of the UV-sol-gel process is the ability to prepare application baths with a higher concentration of precursors, which enables the development of OIH films with much higher film thickness. By harnessing this benefit, a primer-less coating system that can substantially enhance operational efficiency without compromising the performance of the coating system.

### Example 2

UV-curable compositions 100 including hydrolysable silane compound 110 both with and without a Michael addition-based secondary cure system 140 (blocked amine/aminoacetate) as generally illustrated in FIG. 4 were used to form sample coated substrates, which were tested for their various mechanical properties. The results are summarized in Table 2, in which both (i) a rapid cure composition 100 including only the hydrolysable silane compound 110 and (ii) a dual cure composition 100 including the hydrolysable silane compound 110 (fast cure component) and the secondary cure system 140 (slow cure component) were tested.

TABLE 2
Rapid vs. Dual Cure Mechanical Properties

| | Rapid Cure | Dual Cure |
|---|---|---|
| Pencil Hardness | 3H | HB |
| Pendulum Hardness | 85 ± 5 | 70 ± 5 |
| MEK Double Rub | >300 | 90 ± 5 |
| Flexibility (⅛ inch) | Pass | pass |
| Impact Resistance (in*lb) | 60 | >160 |
| Pull-off Strength (MPa) | 1.26 | 4.23 |
| Elongation (%) | 42 | 105 |
| Tensile Strength (MPa) | 1.04 | 1.71 |

### Example 3

FOIH systems with dual-cure mechanisms were prepared as generally illustrated in FIG. 3. The functional precursors (with free hydroxyl, epoxy, carboxylic acid etc.) were mixed with an appropriate ambient-curing type cross-linker, just before the application of wet coating films. An OH-functional silane-type sol-gel precursor was mixed with an isocyanate type crosslinker (at OH/NCO equivalent ratio of 1:00-0.6-0.8) and wet films were applied. Coatings were then exposed under the UV source and cured as described above. In such dual-cure systems, there are two distinct and independent cure mechanisms—(1) base catalyzed sol-gel reaction via silane functionality, and (2) NCO/OH reaction resulting into the formation of polyurethane network. Due to the kinetics of these two mechanisms under a given catalyst type and amount, such systems will not only produce two interconnected OIH polymer networks by completely different and independent reactions, but will occur at different rate. In this case, while sol-gel reaction would occur rapidly using a latent super-base catalyst in the composition, the NCO/OH reaction would be much slower. Such dual-cure coating systems can be used in additive manufacturing (AM) applications. When such a system is used for AM process, the first mechanism (1) above will provide green strength and hence faster processability, while the second mechanism (2) will provide inter-layer crosslinking that significantly improves mechanical properties of the final product. In the present state of AM processes, many AM articles have poor mechanical properties, which is a major limitation that the disclosed dual-cure compositions have the capability to address. Besides these benefits, the dual-cure system brings another significant advantage that would extend its use in geometrically intricate shapes with recessed areas where UV radiation cannot reach. Since the second mechanism is independent of UV radiation, adequate curing can result in such recessed (shadow areas) areas that are not subjected to UV radiation, even then the composition or article as a whole is exposed to UV radiation.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compounds, compositions, methods, and processes are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

What is claimed is:

1. A method for forming an organic-inorganic hybrid (OIH) polymeric composition, the method comprising:
(a) providing a UV-curable composition comprising:
(i) a silane compound comprising at least 3 hydrolysable silyl groups,
(ii) a photo-latent catalyst initiator, and
(iii) a solvent; and
(b) exposing the UV-curable composition to UV radiation (i) to generate a catalyst from the photo-latent catalyst initiator and (ii) to subsequently catalyze with the catalyst condensation of silanol groups formed from hydrolysis of the hydrolysable groups, thereby forming an organic-inorganic hybrid (OIH) polymeric composition.

2. The method of claim 1, wherein the silane compound has a number of hydrolysable silyl groups ranging from 3 to 24.

3. The method of claim 1, wherein the UV-curable composition further comprises:
a second silane compound comprising at least 1 hydrolysable silyl group.

4. The method of claim 1, wherein the hydrolysable silyl groups are selected from the group consisting of alkoxy groups, aryloxy groups, carboxyloxy groups, halogens, and combinations thereof.

5. The method of claim 1, wherein the silane compound comprises a compound (a polyureasil compound) having the formula (I):
R—[—NR₃—CO—NA₁A₂]ₓ; (I)
(i) R is selected from the group consisting of hydrocarbons containing from 1 to 50 carbon atoms and heteroatom-substituted hydrocarbons containing from 1 to 50 carbon atoms;
(ii) A₁ is represented by —R₁—Si(R₃)_{3-y}X_{y};
(iii) A₂ is represented by —R₂—Si(R₃)_{3-z}X_{z} or H;
(iv) X is a hydrolysable group independently selected from the group consisting of alkoxy groups, aryloxy groups, carboxyloxy groups, and halogens;
(v) R₁ and R₂ are independently selected from the group consisting of (A) hydrocarbons containing from 1 to 20 carbon atoms and heteroatom-substituted hydrocarbons containing from 1 to 20 carbon atoms when A₂ is not H, and (B) hydrocarbons containing from 2 to 20 carbon atoms and heteroatom-substituted hydrocarbons containing from 2 to 20 carbon atoms when A₂ is H;
(vi) R₃ is independently selected from the group consisting of H, hydrocarbons containing from 1 to 20 carbon atoms, and heteroatom-substituted hydrocarbons containing from 1 to 20 carbon atoms;
(vii) x is at least 2;
(viii) y is 1, 2, or 3;
(ix) z is 1, 2, or 3 when A₂ is not H; and
(x) the number of hydrolysable groups X is at least 6.

6. The method of claim 1, wherein the silane compound comprises a compound (a polyepoxy compound) having the formula (II):
R—[—C(OH)R₃—NA₁A₂]ₓ; (II)
(i) R is selected from the group consisting of hydrocarbons containing from 1 to 50 carbon atoms and heteroatom-substituted hydrocarbons containing from 1 to 50 carbon atoms;
(ii) A₁ is represented by —R₁—Si(R₃)_{3-y}X_{y};
(iii) A₂ is represented by —R₂—Si(R₃)_{3-z}X_{z} or H;
(iv) X is a hydrolysable group independently selected from the group consisting of alkoxy groups, aryloxy groups, carboxyloxy groups, and halogens;
(v) R₁ and R₂ are independently selected from the group consisting of (A) hydrocarbons containing from 1 to 20 carbon atoms and heteroatom-substituted hydrocarbons containing from 1 to 20 carbon atoms when A₂ is not H, and (B) hydrocarbons containing from 2 to 20 carbon atoms and heteroatom-substituted hydrocarbons containing from 2 to 20 carbon atoms when A₂ is H;
(vi) R₃ is independently selected from the group consisting of H, hydrocarbons containing from 1 to 20 carbon atoms, and heteroatom-substituted hydrocarbons containing from 1 to 20 carbon atoms;
(vii) x is at least 2;
(viii) y is 1, 2, or 3;
(ix) z is 1, 2, or 3 when A₂ is not H; and
(x) the number of hydrolysable groups X is at least 6.

7. The method of claim 1, wherein the photo-latent catalyst initiator comprises a photo-latent base (PLB) initiator and the catalyst formed upon exposure to the UV radiation comprises a base catalyst.

8. The method of claim 7, wherein the PLB initiator comprises a photo-latent base precursor and a blocking group

9. The method of claim 7, wherein the base catalyst is selected from the group consisting of 1,5-Diazabicyclo[4.3.0]non-5-ene (DBN), 1,8-Diazabicyclo[5.4.0]undec-7-ene (DBU), and combinations thereof.

10. The method of claim 1, wherein the photo-latent catalyst initiator comprises a photo-latent acid (PLA) initiator and the catalyst formed upon exposure to the UV radiation comprises an acid catalyst.

11. The method of claim 1, wherein the solvent comprises an organic solvent.

12. The method of claim 1, wherein the UV-curable composition contains 1 wt. % or less water, based on the UV-curable composition.

13. The method of claim 1, wherein:
the silane compound is present in the UV-curable composition in an amount in a range from 5 wt. % to 95 wt. % based on the UV-curable composition;
the photo-latent catalyst initiator is present in the UV-curable composition in an amount in a range from 0.1 wt. % to 10 wt. % based on the UV-curable composition; and
the solvent is present in the UV-curable composition in an amount in a range from 0.1 wt. % to 95 wt. % based on the UV-curable composition.

14. The method of claim 1, wherein the UV-curable composition further comprises:
a polyisocyanate comprising at least two isocyanate groups, and
a polyol comprising at least two hydroxyl groups.

15. The method of claim 14, wherein:
the polyisocyanate comprises a diisocyanate; and
the polyol comprises a diol.

16. The method of claim 14, wherein:
the polyisocyanate is present in the UV-curable composition in an amount in a range from 5 wt. % to 25 wt. % based on the UV-curable composition; and
the polyol is present in the UV-curable composition in an amount in a range from 5 wt. % to 70 wt. % based on the UV-curable composition.

17. The method of claim 1, wherein the UV-curable composition further comprises one or more additives.

18. The method of claim 1, wherein exposing the UV-curable composition to UV radiation comprises irradiating the UV-curable composition with at least one of a mercury lamp and a UV-LED source.

19. The method of claim 1, wherein:
providing the UV-curable composition in part (a) comprises applying the UV-curable composition to a substrate prior to exposing the UV-curable composition to UV radiation; and
exposing the UV-curable composition to UV radiation forms a coating of the OIH polymeric composition on the substrate.

20. The method of claim 19, wherein the substrate comprises aluminum.

21. The method of claim 19, wherein the substrate comprises a material selected from the group consisting of metals, alloys thereof, thermoplastic materials, thermoset materials, composite materials, primer materials, glass, wood, fabric, and ceramic materials.

22. The method of claim 19, wherein the coating has a thickness in the range of 2 μm to 100 μm.

23. The method of claim 19, further comprising:
applying a topcoat layer over the coating.

24. The method of claim 23, wherein the topcoat layer comprises a further OIH polymer composition layer.

25. The method of claim 1, wherein the UV-curable composition is free from Michael-addition (MA) donor and Michael-addition (MA) acceptor compounds.

26. The method of claim 1, wherein the UV-curable composition comprises at least one of a Michael-addition (MA) donor and Michael-addition (MA) acceptor compound.

27. A method of additive manufacturing, the method comprising:
applying a first layer of an additive manufacturing component;
applying an organic-inorganic hybrid (OIH) polymeric composition according to the method of claim 1 on the first layer; and
applying a second layer of an additive manufacturing component on the OIH polymeric composition.

28. An organic-inorganic hybrid (OIH) polymeric composition formed according to the method of claim 1.

29. An organic-inorganic hybrid (OIH) polymeric composition comprising:
a catalyzed reaction product between:
a silane compound comprising at least 3 hydrolysable silyl groups, optionally, a polyisocyanate comprising at least two isocyanate groups, and optionally, a polyol comprising at least two hydroxyl groups; and
a catalyst;
wherein the reaction product comprises:
siloxane condensation bonds of silanol groups formed from hydrolysis of the hydrolysable groups,
optionally urethane bonds between the polyisocyanate and the polyol, when present, and
optionally bonds linking the polyisocyanate and the polyol, when present, to the OIH structure.

30. A coated article comprising:
a substrate; and
the OIH polymeric composition of claim 29 as a coating on a surface of the substrate.
